(19) United States
(12) Patent Application Publication
(10) Pub. No.: US 2016/0030977 A1
(43) Pub. Date: Feb. 4, 2016

(54) HIGH GAS BARRIER THIN FILMS THROUGH PH MANIPULATION OF CLAY

(71) Applicant: Texas A&M University, College Station, TX (US)

(72) Inventors: Jaime C. Grunlan, College Station, TX (US); David A. Hagan, Bryan, TX (US)

(73) Assignee: Texas A&M University, College Station, TX (US)

(21) Appl. No.: 14/879,829

(22) Filed: Oct. 9, 2015

Related U.S. Application Data
(63) Continuation-in-part of application No. 14/430,859, filed on Mar. 24, 2015.
(60) Provisional application No. 62/062,318, filed on Oct. 10, 2014.
(60) Provisional application No. 61/705,029, filed on Sep. 24, 2012.

(51) Int. Cl. B05D 7/00; C09D 179/02

(52) U.S. Cl. CPC B05D 7/582; C09D 179/02; B05D 7/584

(57) ABSTRACT

Bilayers of a polycation and a platelet suspension on a substrate demonstrate significant oxygen barrier properties by altering the pH of the platelet. When the lower pH platelet suspension contacts deposited polycation, more positive charge is created and more platelet suspension is deposited, thereby leading to a thicker film with better gas barrier properties.

### CROSS-REFERENCE TO RELATED APPLICATIONS

This application is a continuation-in-part of U.S. application Ser. No. 14/430,859, filed Mar. 24, 2015, which is the National Stage of International Application No. PCT/US13/00220, filed Sep. 24, 2013, which claims the benefit of U.S. Provisional Application No. 61/705,029, filed Sep. 24, 2012. This application also claims the benefit of U.S. Provisional Application No. 62/062,318, filed Oct. 10, 2014.

### FIELD OF THE INVENTION

The present invention is directed to a multilayer barrier film prepared by a layer by layer process. The multilayer film is an effective barrier for humidity and oxygen.

The disclosure relates generally to methods and compositions of generating a multilayer film prepared by a layer by layer assembly process. More specifically, the process utilizes properties of clay during the manufacture. The disclosure disclosed herein can act as a gas barrier in a variety of food, pharmaceutical, and electronics applications as the film is an effective barrier for humidity and oxygen.

### BACKGROUND OF THE INVENTION

Current flexible display architectures, such as those used for flexible organic light emitting diodes (FOLEDs), require a transparent barrier layer that prevents oxygen gas ingress into the device's active components. These devices require an oxygen transmission rate (OTR) below 10⁻⁵ cc/(m²·day·atm) to achieve sufficient performance requirements (i.e., tens of thousands of hours of operation) in ambient environments. Similar layers with very low permeation rates to atmospheric gases are also key components for a variety of packaging applications, including food and pharmaceuticals. Commonly used metallized plastics have sufficiently low permeation rates for most applications, but lose their utility when product visibility is desired, as in food packaging, or even a requirement, in the case of FOLEDs. A heavily investigated alternative to the metallization of plastics is the deposition of thin metal-oxide layers via vacuum-based processes, such as physical vapor deposition or plasma-enhanced chemical vapor deposition. These inorganic barrier layers exhibit very low OTR at thicknesses as low as 100 nm. Despite exhibiting impressive barrier, low adhesion strength to plastics and inherent brittleness, because they are continuous ceramic sheets, makes these films prone to cracking and loss of barrier performance. Layering these ceramic nanocoatings with UV-curable polymer has been shown to reduce permeability, but these multilayered coatings require very complex fabrication techniques that significantly increase cost.

Clay-filled polymer composites, where individual platelets or stacks of clay platelets are randomly dispersed in bulk polymer, offer an alternative to deposited layers on a plastic substrate. Clay nanoplatelets can be thought of as impermeable barrier particles that extend a penetrating gas molecule's travel due to their creation of a highly tortuous path. The tortuous pathway concept is the key to polymer/clay composites' gas barrier performance. In contrast to fully inorganic coatings, polymer/clay nanocomposites generally maintain desirable mechanical properties. Unfortunately, these composites typically suffer from clay aggregation and random platelet alignment, yielding poor transparency and relatively high gas permeation rates. Recent one-pot mixtures of clay in polymer have led to significant improvements in platelet alignment, but they still exhibit haziness, relatively high OTR values, and are orders of magnitude thicker than ceramic nanocoatings.

A recent review of the clay-based nanocomposites landscape stated the key to success for polymer/clay nanocomposites is the ability to incorporate uniformly dispersed, highly exfoliated, individual clay platelets in a polymer matrix. The literature on this topic further suggests that finding a balance between flexibility, transparency, and barrier is vital to the successful encapsulation of flexible electronic devices.

Despite the advances noted above, there exists a need to for a transparent barrier film that is effective against humidity and oxygen penetration. The present invention seeks to fulfill this need and provides further related advantages.

### SUMMARY

Certain embodiments disclosed herein pertain generally to a method of increasing the thickness of a bilayered oxygen barrier film, the method comprising: obtaining a substrate; exposing the substrate to a polycation solution; and exposing the substrate with the polycation to a platelet solution; wherein the pH of the polycation solution or platelet solution is 6 or less.

Further, in this embodiment, the exposure to a polycation solution and a platelet solution are repeated until a desired number of bilayers is reached. In many embodiments, between each exposure, there is a rinsing step using water and a drying step. Still further, the exposure comprises dipping for about one minute. It is conceivable, however, that the duration of the dipping process can be instantaneous or up to a minute in most applications. Likewise, the dipping process can be several minutes or several hours or some time duration in between.

In certain embodiments, the methods result in a film of a thickness of greater than 150 nm when 10 bilayers are present and the pH of the polycationic solution or platelet solution is about 5 or lower. Likewise, the film has a thickness of greater than 250 nm when 10 bilayers are present and the pH of the polycationic solution or platelet solution is about three or lower.

In the aforementioned embodiments, the polycation can be any number of different polycations. In certain embodiments, the polycation is linear polyethylenimine (LPEI), branched polyethylenimine (BPEI), poly(allyl amine), poly(vinyl amine), cationic polyacrylamide, cationic polydiallyldimethylammonium chloride (PDDA), polymelamine and copolymers thereof, polyvinylpyridine and copolymers thereof, and combinations thereof.

Likewise, in the aforementioned embodiments, the platelet solution is an anionic platelet solution and the anionic platelet is a clay such as montmoroillonite or vermiculite; mica; zirconium phosphate; a graphene or some combination thereof.

In these aforementioned embodiments, when at least 10 bilayers are used, the film provides an oxygen transmission rate (OTR) of less than 0.5 (cc/(m²·day·atm)).

While the embodiments contemplate that any substrate can be used provided it results in the properties listed above, in certain embodiments, the substrate is a polyethylene terephthalate (PET) film. In still other embodiments, the substrate can be oriented polypropylene (OPP), polystyrene (PS) and the like.

Other embodiments of the disclosure concern a film made by one or more of the methods listed above.

An embodiment of the disclosure is a method of preparing an oxygen barrier film, the method comprising: a. obtaining a substrate; b. exposing the substrate to a polycation solution with a pH of 6 or less to form a first layer; and c. exposing the substrate with the polycation to a platelet solution to form a second layer; wherein the first layer and second layer together form a bilayer; and wherein the oxygen transmission rate of the oxygen barrier film is decreased compared to the oxygen transmission rate of the substrate. In an embodiment, steps b and c are repeated until the number of bilayers reaches at least 10 bilayers. In an embodiment, the thickness of the at least 10 bilayers is greater than 100 nm. In an embodiment, the pH of the polycation solution or platelet solution is about 5 or less. In an embodiment, the thickness of the at least 10 bilayers is at least 150 nm. In an embodiment, the pH of the polycation solution or platelet solution is about 3 or less. In an embodiment, the thickness of the at least 10 bilayers is at least 250 nm. In an embodiment, the method further comprises rinsing with water after step b and after step c. In an embodiment, the method further comprises drying after rinsing with water. In an embodiment, exposing comprises dipping in a solution, spraying or flexographic printing. In an embodiment, the method is layer by layer assembly. In an embodiment, the polycation is selected from the group consisting of linear polyethylenimine (LPEI), branched polyethylenimine (BPEI), poly(allyl amine), poly(vinyl amine), cationic polyacrylamide, cationic polydiallyldimethylammonium chloride (PDDA), polymelamine and copolymers thereof, polyvinylpyridine and copolymers thereof, and combinations thereof. In an embodiment, the substrate is polyethylene terephthalate. In an embodiment, the platelet solution is an anionic platelet solution. In an embodiment, the anionic platelet is selected from the group consisting of montmoroillonite, vermiculite, mica, zirconium phosphate, a graphene and a combination thereof. In an embodiment, the anionic platelet is montmoroillonite. In an embodiment, the at least 10 bilayers provide an oxygen transmission rate of less than 0.5 OTR (cc/(m²·day·atm)).

An embodiment of the disclosure is an oxygen bather film made by the method above.

Other objects, features and advantages of the present disclosure will become apparent from the following detailed description. It should be understood, however, that the detailed description and the specific examples, while indicating preferred embodiments of the disclosure, are given by way of illustration only, since various changes and modifications within the spirit and scope of the disclosure will become apparent to those skilled in the art from this detailed description.

### DESCRIPTION OF THE DRAWINGS

In order that the manner in which the above-recited and other enhancements and objects of the disclosure are obtained, we briefly describe a more particular description of the disclosure briefly rendered by reference to specific embodiments thereof which are illustrated in the appended drawings. Understanding that these drawings depict only typical embodiments of the disclosure and are therefore not to be considered limiting of its scope, we herein describe the disclosure with additional specificity and detail through the use of the accompanying drawings in which:

FIG. 1 is a schematic illustration of a representative coated structure of the invention in which the coating is a bilayer.

FIG. 2 is a schematic illustration of a representative coated structure of the invention in which the coating is a quadlayer.

FIG. 3 is a schematic illustration of a representative coated structure of the invention in which the coating is a 4× bilayer.

FIG. 4 is a schematic illustration of a representative coated structure of the invention in which the coating is a 4× quadlayer.

FIG. 5A is a schematic of a representative LbL assembly with cationic polyethylenimine (PEI) and anionic vermiculite (VMT) clay and a cross-sectional illustration of the resultant thin film. FIG. 5B illustrates thickness as a function of PEI/VMT bilayers deposited. The inset shows mass deposition as a function of bilayers deposited, with half bilayers representing PEI deposition. VMT structure legend: • Mg, Fe, Al; ◯ O1; ∘ Si, Al; O2,3; [symbol] Mg.

FIG. 6A illustrates visible light transmission as a function of wavelength for PEI/VMT films deposited onto quartz glass. Inset shows average visible light transmission as a function of bilayers deposited. FIG. 6B is an image of a half-coated media player screen is shown to highlight transparency of representative coatings of the invention.

FIG. 7A is a TEM image of 12 PEI/VMT bilayers deposited onto PET film. The arrow spans the LbL film thickness. FIG. 7B compares oxygen transmission rate and oxygen permeability as function of PEI/VMT bilayers (filled points) and a 20 BL PEI/MMT (montmorillonite) film (unfilled point) deposited onto PET.

FIG. 8 compares oxygen (OTR) and water vapor (WVTR) transmission rates of 179 μm PET film and 20BL VMT-based assemblies on 179 μm PET film.

FIG. 9 are schematic illustrations of (a) LbL deposition and (b) 3 BL cross-section.

FIG. 10 is an illustration of (a) Zeta potential of MMT clay and (b) an illustration of clay deposition onto PEI surface as a function of clay suspension pH.

FIG. 11 is a graphical representation of (a) thickness of PEI₁₀/MMTₓ measured with profilometry and (b) mass deposition of PEI₁₀/MMTₓ systems at clay pH of 4 and 10.

FIG. 12 represents TEM micrographs of 10 BL of (a) PEI/MMT₁₀, (b) PEI/MMT₄, and (c) PEI/MMT₃.

FIG. 13 is AFM topography (a,b,d,e) and phase images (c,f) of [PEI/MMT₁₀]₁₅ (top—a,b,c) and [PEI₁₀/MMT₃]₁₅ (bottom—d,e,f). The phase images highlight the cobblestone path structure of the MMT covered surface.

FIG. 14 is a graphical representation of PEI/clay bilayers where the number denotes pH of the clay suspension. The lines are only meant as a guide. *PEI/VMT results are from previous study.34

### LIST OF REFERENCE NUMERALS

100 representative structure
110 substrate
120 first layer
130 second layer
350 bilayer
200 representative structure
210 substrate
220 first layer
230 second layer
240 third layer
250 fourth layer
450 quadlayer

### DETAILED DESCRIPTION OF THE INVENTION

We show the particulars shown herein by way of example and for purposes of illustrative discussion of the preferred embodiments of the present disclosure only. We present these particulars to provide what we believe to be the most useful and readily understood description of the principles and conceptual aspects of various embodiments of the disclosure. In this regard, we make no attempt to show structural details of the disclosure in more detail than is necessary for the fundamental understanding of the disclosure. We intend that the description should be taken with the drawings. This should make apparent to those skilled in the art how the several forms of the disclosure are embodied in practice.

We have found herein that bilayers of polyethylenimine (PEI) and montmoroillonite (MMT) clay have significant oxygen barrier properties. By altering the pH of the MMT clay suspension, the charge of the deposited PEI layer can be increased, which causes more MMT clay to be deposited leading to a thicker film with better gas barrier properties.

The present invention provides multilayer films that are effective barriers for humidity and oxygen, articles of manufacture that include the films, and methods for making and using the films.

In one aspect of the invention, a coated structure is provided. The coated structure, comprises a substrate having a surface and a coating substantially covering the surface. In one embodiment, the coating comprises: (a) a first layer comprising a polycation, a polyanion, or a polar, non-ionic, water-soluble polymer; and (b) a second layer comprising a platelet having a water content of less than 7% by weight. In certain embodiments, the first layer is intermediate the substrate and second layer. In other embodiments, the second layer is intermediate the substrate and first layer.

In general, the choice of a polycation or a polyanion in first layer will depend on the selection of the platelet. If the platelet is negatively charged, then the first layer will include a polycation and the second layer will include the negatively charged platelet. Conversely, if the platelet is positively charged, then the first layer will include a polyanion and the second layer will include the positively charged platelet. Thus, a coating having layers that include the polycation and/or polyanion relies on the electrostatic interaction between them and the platelet to provide the coating (e.g., adjacent layers are oppositely charged). A coating having layers that include the polar, non-ionic, water-soluble polymer relies on hydrogen-bonding, as well as relatively weaker electrostatic interactions, between adjacent layers (e.g., layers including the platelet, a polycation, a polyanion, or another polar, non-ionic, water-soluble polymer).

In the practice of the layer-by-layer process of the invention, coatings are formed by sequential deposition of layers. The deposition of materials making up a new layer onto the deposited materials making up an existing first layer can result in the materials of the new layer penetrating the material of the existing layer to provide a region in the coating where the materials of the new and existing layers are mixed. The extent and depth of the mixing between adjacent layers will depend on the nature of the materials and the deposition process. Although the coatings of the invention described as multilayer, it will be appreciated that interaction between layers exists and that the interaction can range from an interface between the two layers to a zone between the two layers in which materials from adjacent layers are mixed.

When the platelet is applied directly to the substrate surface (i.e., the second layer is intermediate the surface and the first layer), there is an association between the surface and the platelet sufficient to provide a stable coated structure. The association can be an electrostatic association where the platelet has a net negative charge and the surface has a net positive charge, or alternatively, the platelet has a net positive charge and the surface has a net negative charge. The association can be based on polarity where the platelet has a polarity opposite that of the surface. The associate can be based on hydrogen bonding between the platelet and the substrate surface.

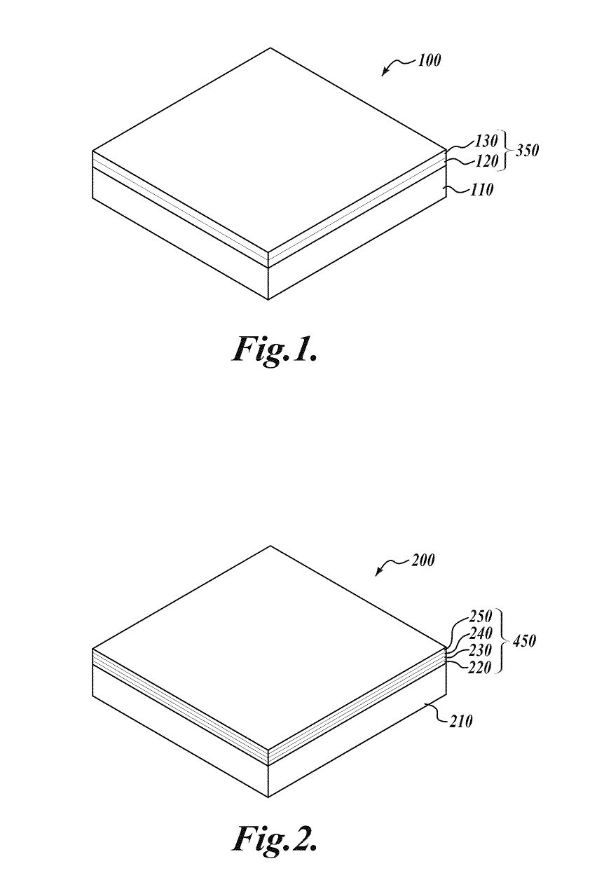

In one embodiment, the coated structure includes only a first layer and a second layer as described above and the coating is a bilayer. A schematic illustration of a representative bilayer coating of the invention is illustrated in FIG. 1. Referring to FIG. 1, representative structure 100 includes substrate 110 having first layer 120 that is coextensive with a surface of the substrate, and second layer 130 that is coextensive with a surface of the first layer. Structure 100 includes substrate 110 and bilayer 350.

The coated structures of the invention include at a minimum the first and second layers described above. It will be appreciated that a great variety of coated structures can be readily prepared by the layer-by-layer process described herein. Beyond the first and second layers described above, the number and nature of layers in a coated structure of the invention can be widely varied provided that adjacent layers have an association sufficient to provide a stable coating.

In another embodiment, the invention provides a coated substrate having four layers (e.g., a quadlayer). In this embodiment, the coating described above further includes (c) a third layer comprising a polycation, a polyanion, or a polar, non-ionic, water-soluble polymer, wherein the third layer comprises a polycation when the first layer comprises a polyanion, and wherein the third layer comprises a polyanion when the first layer comprises a polycation; and (d) a fourth layer comprising a polycation, a polyanion, or a polar, non-ionic, water-soluble polymer, wherein the fourth layer comprises a polycation when the third layer comprises a polyanion, and wherein the fourth layer comprises a polyanion when the third layer comprises a polycation. In certain embodiments, the third layer is intermediate the first and second layers. In certain embodiments, the fourth layer is intermediate the third and second layers.

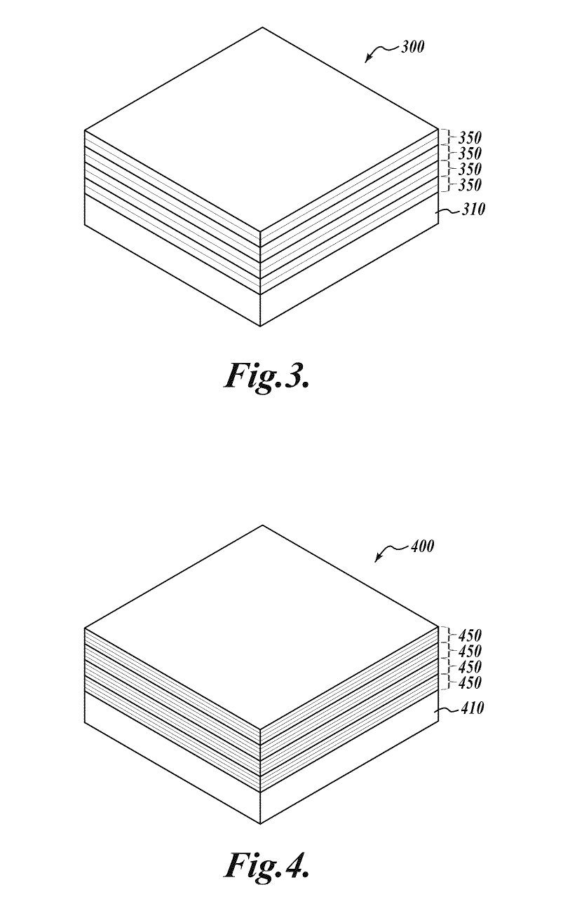

In one embodiment, the coated structure includes only first, second, third, and fourth layer as described above and the coating is a quadlayer. A schematic illustration of a representative quadlayer coating of the invention is illustrated in FIG. 2. Referring to FIG. 2, representative structure 200 includes substrate 210 having first layer 220 that is coextensive with a surface of the substrate, second layer 230 that is coextensive with a surface of first layer 220, third layer 240 that is coextensive with a surface of second layer 230, and fourth layer 250 that is coextensive with a surface of third layer 240. Structure 200 includes substrate 210 and quadlayer 450.

In other embodiments, the present invention provides coated structures comprising the bilayers and quadlayers described herein.

In one embodiment, multi-bilayer-coated structures are provided. In this embodiment, the coated structure comprises:

(a) a substrate having a surface; and

(b) a coating substantially covering the surface, the coating comprising a plurality of alternating first and second layers, wherein

(i) the first layer comprises a polycation, a polyanion, or a polar, non-ionic, water-soluble polymer, and

(ii) the second layer comprises a platelet having a water content of less than 7% by weight.

A schematic illustration of a representative multi-bilayer coating of the invention is illustrated in FIG. 3. Referring to FIG. 3, representative structure 300 includes substrate 310 having four bilayers 350.

In another embodiment, multi-quadlayer-coated structures are provided. In this embodiment, the coated structure comprises:

(a) a substrate having a surface; and

(b) a coating substantially covering the surface, the coating comprising a plurality of multilayers, each multilayer comprising in sequence a first, a second, a third, and a fourth layer, wherein

(i) the first layer comprises a polycation, a polyanion, or a polar, non-ionic, water-soluble polymer, and

(ii) the second layer comprising a polycation, a polyanion, or a polar, non-ionic, water-soluble polymer, wherein the second layer comprises a polycation when the first layer comprises a polyanion, and wherein the second layer comprises a polyanion when the first layer comprises a polycation;

(iii) the third layer comprising a polycation, a polyanion, or a polar, non-ionic, water-soluble polymer, wherein the third layer comprises a polycation when the second layer comprises a polyanion, and wherein the third layer comprises a polyanion when the third layer comprises a polycation, and

(iv) the fourth layer comprises a platelet having a water content of less than 7% by weight.

In a further embodiment, the coated structure of the invention includes a trilayer coating. In certain embodiments, the trilayer coating includes (a) first layer comprising a polycation, a polyanion, or a polar, non-ionic, water-soluble polymer, (b) a second layer comprising a polycation, a polyanion, or a polar, non-ionic, water-soluble polymer, wherein the second layer comprises a polycation when the first layer comprises a polyanion, and wherein the second layer comprises a polyanion when the first layer comprises a polycation, and (c) a third layer comprising a platelet having a water content of less than 7% by weight.

A representative trilayer coating includes a first layer comprising a polyethylenimine, a second layer comprising a polyacrylic acid, and a third layer comprising vermiculite. Another representative trilayer coating includes a first layer comprising a polyethylenimine, a second layer comprising a polyethylene oxide, and a third layer comprising vermiculite.

As described above for the bilayer and quadlayer coatings, coated structures of the invention can also include multiple trilayers. It will be appreciated that coated structures of the invention that include multiple layers need not include solely bi-, tri-, or quadlayers (e.g., a coated structure in which the coating is a plurality of bi-, tri-, or quadlayers). The coated structures of the invention that include multiple layers can include a combination of bi-, tri-, quad- or higher order layers.

As noted above, the number and nature of layers in the coating of the coated structures of the invention can be widely varied. Thus, in certain embodiments, the invention provides a coated structure, comprising:

(a) a substrate having a surface; and

(b) a coating substantially covering the surface, the coating comprising a plurality of layers, wherein each layer comprises

(i) a polycation, a polyanion, or a polar, non-ionic, water-soluble polymer, or

(ii) a platelet having a water content of less than 7% by weight, wherein each layer comprising the platelet has adjacent layers comprising a polycation, a polyanion, or a polar, non-ionic, water-soluble polymer, and wherein the coating comprises one or more layers comprising the platelet.

It will be appreciated that the platelet-containing layer can be immediately adjacent the substrate surface in any of the coated structures of the invention.

The coated structures of the invention include at least one layer that includes a platelet having a water content of less than 7% by weight. Coated structures of the invention can include platelet-containing layers in which the platelet differs from other platelet-containing layers by their water content or by the nature of the platelet itself (e.g., a coated structure with vermiculite in one or more layers and mica in one of more layers).

For the coated structures of the invention, the substrate can be any suitable substrate having a surface that benefits from the barrier that the coating provides. Suitable substrates include sheets, films, and fibers. In certain embodiments, the substrate is polymeric. Suitable polymers include polyesters, polyamides, polyimides, polyolefins, and vinyl polymers. Representative polyesters include polyethylene terephthalate, polyethylene naphthalate, polylactic acid, polybutylene succinate, polyglycolic acid, and polyhydroxyalconates. Representative polyamides include nylons. Representative polyolefins include polyethylene, polypropylene, polyethylene vinyl acetate, maleic anhydride grafted polyethylene, polyethylene acrylic acid. Representative vinyl polymers include polystyrene and polyvinyl chloride. Another representative useful polymer is polyethersulfone. Combinations of polymers are also suitable.

Suitable substrates that can be advantageously coated in accordance with the invention include substrates having more than one surface (e.g., a film having two major surfaces). The surfaces of such substrates can be selectively coated. Coated structures of the invention include structures having more than one coated surface (e.g., both major surfaces of a film).

Suitable substrates also include laminated polymeric substrates and co-extruded substrates. A laminated substrate includes two or more adhered polymeric materials (e.g., first polymer substrate|adhesive|second polymer substrate|adhesive|third polymer substrate). A co-extruded polymeric substrate is a substrate formed by co-extrusion of a multiple polymers.

In addition to synthetic polymeric substrates, suitable substrates include cellulosic substrates such as paper, fabrics, and textiles.

The substrates that are advantageously coated included substrates having formed surfaces (i.e., surfaces that on a macroscopic level are not flat).

In certain embodiments, the coated structures of the invention include a coating that includes a polycation. A used herein the term “polycation” refers to a polyelectrolyte having an overall positive charge or that can become positively charged depending on the pH of the environment (e.g., protonation of an amine group at lower pH). Representative polycations include linear polyethylenimine (LPEI), branched polyethylenimine (BPEI), poly(allyl amine), poly(vinyl amine), cationic polyacrylamide, cationic polydiallyldimethylammonium chloride (PDDA), polymelamine and copolymers thereof, polyvinylpyridine and copolymers thereof, and combinations thereof.

In certain embodiments, the coated structures of the invention include a coating that includes a polyanion. A used herein the term “polyanion” refers to a polyelectrolyte having an overall negative charge or that can become negatively charged depending on the pH of the environment (e.g., deprotonation of a carboxylic acid at higher pH). Representative polyanions include homopolymers and copolymers of acrylic acid, methacrylic acid, ethacrylic acid, maleic acid, itaconic acid, fumeric acid, styrene sulfonic acid, and vinyl phosphonic acid, and combinations thereof.

In certain embodiments, the coated structures of the invention include a coating that includes a polar, non-ionic, water-soluble polymer. A used herein the term “polar, non-ionic, water-soluble polymer” refers to a polymer that is polar (i.e., includes atoms having differing electronegativities), non-ionic (i.e., no charge), and is substantially water soluble. Representative polar, non-ionic, water-soluble polymers include polyalkylene oxide polymers (e.g., polymers and copolymers of ethylene oxide and propylene oxide), polyvinylpyrrolidone polymers, and polyvinyl alcohol polymers, and combinations thereof.

The coated structures of the invention include a platelet. Suitable platelets include naturally occurring inorganic materials (e.g., clays and minerals) and synthetic materials. Representative platelets include minerals such as vermiculite and mica; zirconium phosphate, and graphenes including graphene oxide and surface modified graphenes.

To facilitate the advantageous properties achieved by the coating of the structures of the invention, the platelet has an average aspect ratio from about 100 to about 20,000. In certain embodiments, the platelet has an average aspect ratio from about 200 to about 10,000. In some embodiments, the average aspect ratio is greater than 100; in other embodiments, greater than 500; in further embodiments, greater than 700, and in yet other embodiments, greater than 900. As used herein, the term “aspect ratio” refers to the ratio of platelet thickness to platelet diameter. Because platelet thickness is about 1 nm, the aspect ratio is the platelet diameter. “Average aspect ratio” refers to the average ratio for platelets in the layer.

As noted above, to facilitate the advantageous properties achieved by the coating of the structures of the invention, the platelet has a water content of less than 7% by weight based on the total weight of the platelet, preferably less than about 5%, and more preferably less than about 3%. In certain embodiments, the platelet has a water content from about 0.5 to about 5% by weight. In other embodiments, the platelet has a water content from about 1 to about 3% by weight. The water content of clay materials (e.g., vermiculite) is described in Grim, R. E., Applied Clay Mineralogy; McGraw-Hill: New York, N.Y., 1962; and Given, N., Pollastro, R. M., Society, C. M., Clay-Water Interface and its Rheological Implications; The Clay Minerals Society, 1992. Platelet water content can be measured by a moisture balance at 105° C. and after equilibrating the platelet for 72 hr at 50% relative humidity and 23° C.

For platelets that are hydrophobic and that are not capable of being suspended in a solvent useful for making coated structures of the invention, the platelet can be stabilized through the use of a surfactant. Surfactant stabilized platelets can be suspended in a useful solvent (e.g., water) thereby facilitating the formation of coatings that include hydrophobic platelets that cannot otherwise be processed in accordance with the methods of the invention.

In certain embodiments, the platelet has a surface charge greater than about 3-300 meq/100 g. See, for example, Grim, R. E., Applied Clay Mineralogy; McGraw-Hill: New York, N.Y., 1962.

The coating of the structures of the invention can include layers of varying thickness. The layers in a coating can be substantially the same (i.e., within 5 or 10% of each other) or the thickness may differ from layer to layer. Representative layer thickness ranges from about 1 to about 100 nm.

In certain embodiments, the structures of the invention have coating that are substantially transparent (e.g., greater than 90% transmission at visible wavelengths, 390 to 750 nm).

The coatings impart an advantageous average oxygen transmission rate (OTR) to the coated structures. The rates are generally dependent on the nature and number of layers. In certain embodiments, the coated structures have an average oxygen transmission rate less than about 5 cc/(m²day atm), preferably less than about 1.5 cc/(m²day atm), and more preferably less than about 1.0 cc/(m²day atm). Certain coated structures of the invention have undetectable average oxygen transmission rates (<0.005 cc/(m²day atm). In certain embodiments, the coated structures have an average oxygen transmission rate of from about 0.005 to about 5 cc/(m²day atm). In other embodiments, the coated structures have an average oxygen transmission rate of from about 0.005 to about 1.5 cc/(m²day atm). In further embodiments, the coated structures have an average oxygen transmission rate of from about 0.005 to about 1.0 cc/(m²day atm). For an exemplary structure having five (5) quadlayers, the average OTR was 0.18 at 50% relative humidity (RH), and for a structure having four (4) quadlayers, the average OTR was 0.60 at 50% RH. For an exemplary structure having twenty (20) bilayers, the average OTR was 0.017 at 0% RH and 0.71 at 100% RH. OTR is measured (on 179 μm thick PET) using an Oxtran 2/21 ML in accordance with ASTM D-3985 at 0% and 100% RH.

The coatings impart an advantageous average water vapor transmission rate (WVTR) to the coated structures. As noted above, the rates are generally dependent on the nature and number of layers. In certain embodiments, the coated structures have an average water vapor transmission rate less than about 3 g/(m²day) at 23° C. and 100% humidity, preferably less than about 2 g/(m²day), and more preferably less than about 1 g/(m2day). In certain embodiments, the coated structures have an average water vapor transmission rate of from about 0.05 to about 3 g/(m²day). In other embodiments, the coated structures have an average water vapor transmission rate of from about 0.1 to about 2 g/(m²day). In further embodiments, the coated structures have an average water vapor transmission rate of from about 0.1 to about 1.0 g/(m²day atm). For an exemplary structure having twenty (20) bilayers, the average WVTR was 0.65 at 100% relative humidity (RH). WVTR is measured by ASTM F-1249 (MOCON, 23° C. and 100% RH).

In another aspect, the invention provides articles of manufacture that include the coated structures of the invention. Representative articles include packaging material, for example for food and pharmaceuticals; display devices such as electronic devices, organic light emitting diodes, and touchscreen surfaces.

In a further aspect of the invention, methods for making coated structures are provided. The methods are referred to layer-by-layer methods because each layer of the coating is formed on a previously formed layer.

In one embodiment, the invention provides a method for making a coating on a substrate, where the coating includes two layers. In this embodiment, the method includes:

(a) contacting a substrate with a first solution comprising a polycation, a polyanion, or a polar, non-ionic, water-soluble polymer to provide a substrate having a surface coated with a polycation, a polyanion, or a polar, non-ionic, water-soluble polymer;

(b) optionally rinsing the coated surface;

(c) optionally drying the coated surface;

(d) contacting the coated surface with a second solution comprising a platelet having a water content less than 7% to provide a platelet coated surface;

(e) optionally rinsing the platelet coated surface; and

(f) optionally drying the platelet coated surface.

In embodiments where the coating only includes two layers, the coating is a bilayer, as described above.

In certain embodiments, a multilayer film is prepared and the above method further includes:

(g) contacting the platelet coated surface with a first solution comprising a polycation, a polyanion, or a polar, non-ionic, water-soluble polymer to provide a substrate having a surface coated with a polycation, a polyanion, or a polar, non-ionic, water-soluble polymer;

(h) optionally rinsing the coated surface;

(i) optionally drying the coated surface;

(j) contacting the coated surface with a second solution comprising a platelet having a water content less than 7% to provide a platelet coated surface;

(k) optionally rinsing the platelet coated surface; and

(l) optionally drying the platelet coated surface.

The above method is effective to provide a two (2) bilayer coating.

In a further embodiment, a multilayer film is prepared and the above method further includes repeating steps (g) through (l) n times, where n is an integer from 1 to 30. This embodiment is effective to provide an n x bilayer coating.

In another embodiment, the invention provides a method for making a coating on a substrate, where the coating includes four layers. In this embodiment, the method includes:

(a) contacting a substrate with a first solution comprising a polycation, a polyanion, or a polar, non-ionic, water-soluble polymer to provide a substrate having a surface coated with a polycation, a polyanion, or a polar, non-ionic, water-soluble polymer;

(b) optionally rinsing the coated surface;

(c) optionally drying the coated surface;

(d) contacting the coated surface with a second solution comprising a polycation, a polyanion, or a polar, non-ionic, water-soluble polymer to provide a substrate having a surface coated with a polycation, a polyanion, or a polar, non-ionic, water-soluble polymer, wherein the second solution comprises a polycation when the first solution comprises a polyanion, and wherein the second solution comprises a polyanion when the first solution comprises a polycation;

(e) optionally rinsing the coated surface;

(f) optionally drying the coated surface;

(g) contacting the coated surface with a third solution comprising a polycation, a polyanion, or a polar, non-ionic, water-soluble polymer to provide a substrate having a surface coated with polycations or polyanions, wherein the third solution comprises a polycation when the second solution comprises a polyanion, and wherein the third solution comprises a polyanion when the second solution comprises a polycation;

(h) optionally rinsing the coated surface;

(i) optionally drying the coated surface;

(j) contacting the coated surface with a fourth solution comprising a platelet having a water content of less than 7% to provide a platelet coated surface;

(k) optionally rinsing the platelet coated surface; and

(l) optionally drying the platelet coated surface.

In embodiments where the coating only includes four layers, the coating is a quadlayer, as described above.

In certain embodiments, a multilayer film is prepared and the above method further includes:

(m) contacting the platelet coated surface with a first solution comprising a polycation, a polyanion, or a polar, non-ionic, water-soluble polymer to provide a substrate having a surface coated with a polycation, a polyanion, or a polar, non-ionic, water-soluble polymer;

(n) optionally rinsing the coated surface;

(o) optionally drying the coated surface;

(p) contacting the coated surface with a second solution comprising a polycation, a polyanion, or a polar, non-ionic, water-soluble polymer to provide a substrate having a surface coated with a polycation, a polyanion, or a polar, non-ionic, water-soluble polymer, wherein the second solution comprises a polycation when the first solution comprises a polyanion, and wherein the second solution comprises a polyanion when the first solution comprises a polycation;

(q) optionally rinsing the coated surface;

(r) optionally drying the coated surface;

(s) contacting the coated surface with a third solution comprising a polycation, a polyanion, or a polar, non-ionic, water-soluble polymer to provide a substrate having a surface coated with a polycation, a polyanion, or a polar, non-ionic, water-soluble polymer, wherein the third solution comprises a polycation when the second solution comprises a polyanion, and wherein the third solution comprises a polyanion when the second solution comprises a polycation;

(t) optionally rinsing the coated surface;

(u) optionally drying the coated surface;

(v) contacting the coated surface with a fourth solution comprising a platelet having a water content of less than 7% to provide a platelet coated surface;

(w) optionally rinsing the platelet coated surface; and

(x) optionally drying the platelet coated surface.

The above method is effective to provide a two (2) quadlayer coating.

In a further embodiment, a multilayer film is prepared and the above method further includes repeating steps (m) through (x) n times, where n is an integer from 1 to 30. This embodiment is effective to provide an n x quadlayer coating.

In the above methods, contacting can include dip coating, spray coating, roll coating, or printing.

In the above methods, the solvent for the polycation, polyanion, or polar, non-ionic, water-soluble polymer can be deionized water; the solvent for the platelet can be deionized water, and rinsing can include rinsing with deionized water.

In the above methods, the product coated structure is dried, typically by subjecting the coated structure to elevated temperature (e.g., 70° C.) for a period of time (e.g., 15 min.)

The coated structures of the invention can be subjected to additional treatments that further enhance the advantageous properties of these structures. Representative treatments include chemical crosslinking. Intermediate layers formed during the preparation process can be subject to additional treatment (e.g., crosslinking) to enhance the properties of the product coated structure.

The following is a description of representative multilayer barrier films, their preparation, and their properties.

Layer-by-layer (LbL) assembly is a relatively inexpensive water-based coating technique that utilizes the natural complexation of oppositely charged (or otherwise functionalized) species onto a surface. The sequential exposure of a substrate to alternating cationic and anionic mixtures yields nanometer-scale buildup of multilayered, multifunctional thin films, where these mixtures often contain nanoparticles. LbL deposition produces composites of highly aligned and exfoliated clay layers in a polymer matrix that remain transparent, flexible and exhibit super gas barrier properties (OTR<0.005 cc/(m²·day·atm).

The impressive gas barrier that is reported is believed to be due to a highly aligned, nanobrick wall structure that creates extreme tortuosity for gas molecule diffusion. This type of tortuous pathway was previously modeled resulting in a mathematical representation of relative permeability:

$$\frac{{P}_{o}}{P} = 1 + {μα}^{2} ( \frac{{φ}^{2}}{1 - φ} ) , \qquad ( 1 )$$

where Pₒ is the polymer matrix permeability, P is the composite permeability, μ is a filler geometric factor, α is the filler aspect ratio, defined as (l/2)/d, and φ is the volume fraction of filler. This model predicts that larger aspect ratio fillers will improve the barrier of polymer nanocomposites, with relative permeability (Pₒ/P) scaling with the square of α (Eq. 1).

The present invention provides a method for LbL assembly of cationic, branched polyethylenimine (PEI) and anionic, large aspect ratio vermiculite clay (VMT), which results in films that exhibit unprecedented optical clarity and super gas barrier when deposited on PET film.

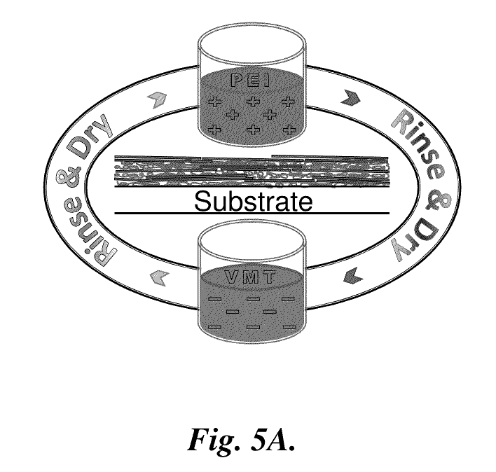

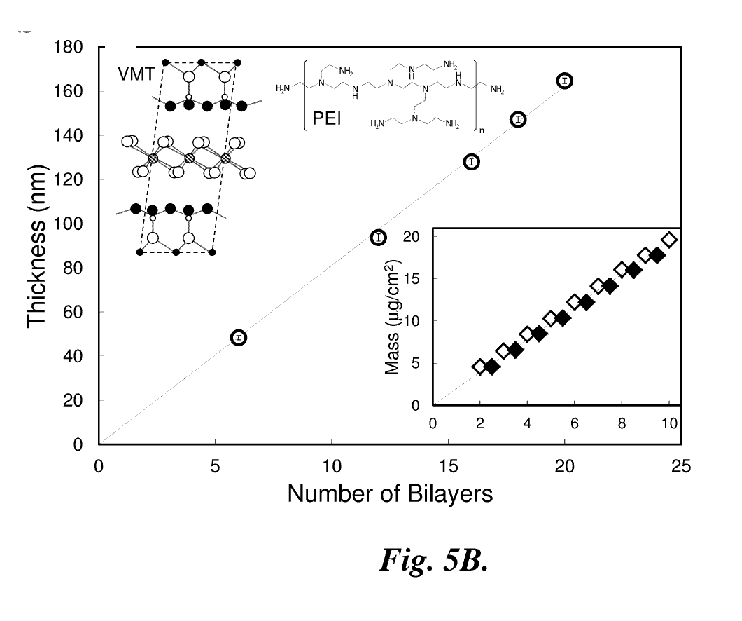

Bilayers were deposited, from 0.1 wt % solutions of pH 10 PEI and 2 wt % suspensions of VMT (illustrated in FIG. 5A), onto a silicon wafer to monitor film growth as a function of layers deposited, as shown in FIG. 5B. Film growth is shown to increase linearly as a function of bilayers deposited, with a growth rate of approximately 8 nm per bilayer, suggesting that all vermiculite deposition is oriented parallel to the substrate. Any significant misorientation of platelets would result in film thickness values on the order of hundreds of nanometers after only a few layers due to the large size of individual VMT platelets (average effective diameter about 1.1 μm). Mass deposited per layer exhibits a similar linear growth trend as shown for film thickness, as shown in FIG. 5C, and reveals incredibly high clay concentration at 96.6 wt %. These data support the idea of multi-platelet deposition per layer and represent the highest clay concentration ever reported for a dense polymer nanocomposite (ρ about 2.4 g/cm³). With a thickness per bilayer around 8 nm, these stacks of platelets could total no more than four or five in each layer, which is excellent exfoliation for platelets with α>1000.

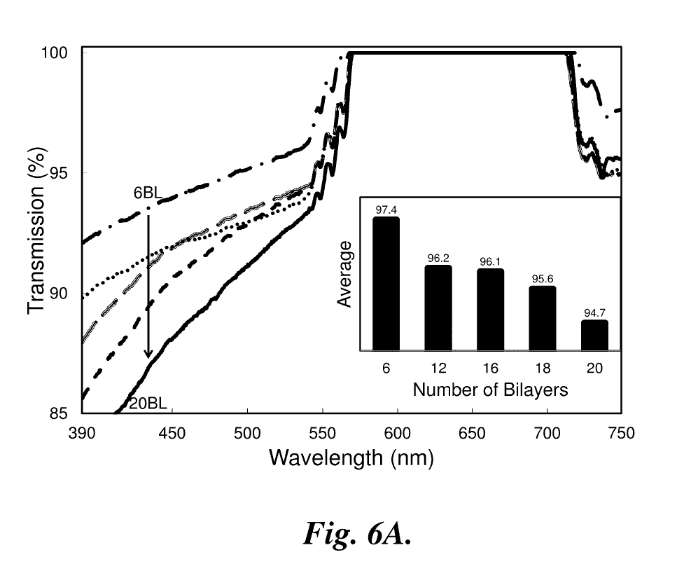

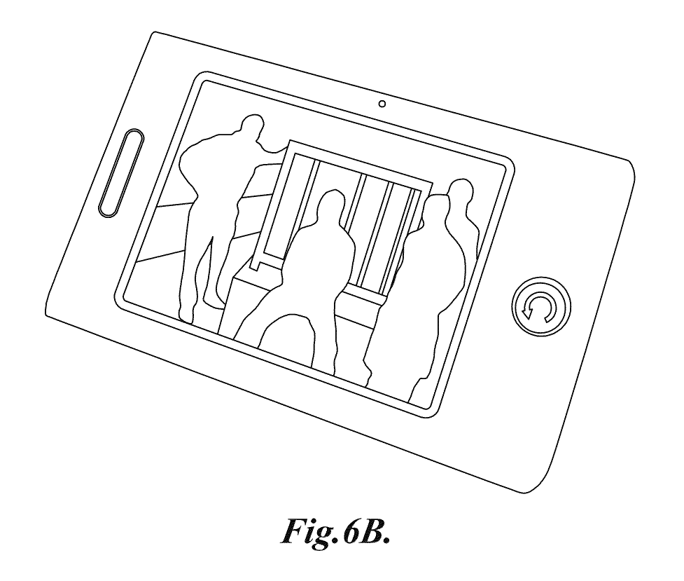

UV-vis spectroscopy (FIG. 6A) reveals that, even at such high clay concentration, these films exhibit excellent transparency throughout the visible light spectrum (390-750 nm). 20 BL films achieve visible light transparency greater than 94.7%, providing further evidence that clay deposition occurs in a highly oriented and exfoliated manor. Even a modest lack of clay orientation, or significant platelet stacking, with each layer deposited would have compounding effects on light transmission, exponentially decreasing transparency as a function of layers deposited, which is not exhibited here. FIG. 6B shows a 20-bilayer coating deposited directly onto the surface of a touchscreen media player to highlight the transparency and utility of these films as an encapsulation layer for electronic displays. The coating was applied using a LbL dipping process and the nearly imperceptible line running across the center of the screen is the top of the coating. The uncoated portion of the screen shows minimal differences in display emission when compared to the coated portion, with little discernible difference when viewed at varying angles. This transparency is achieved only when clay platelets deposit in the film in a highly exfoliated state, where the thickness of individual platelets is too small to interact with visible light transmission. Also, the deposition of this nanocoating directly onto the touchscreen's surface did no harm to the touch functionality.

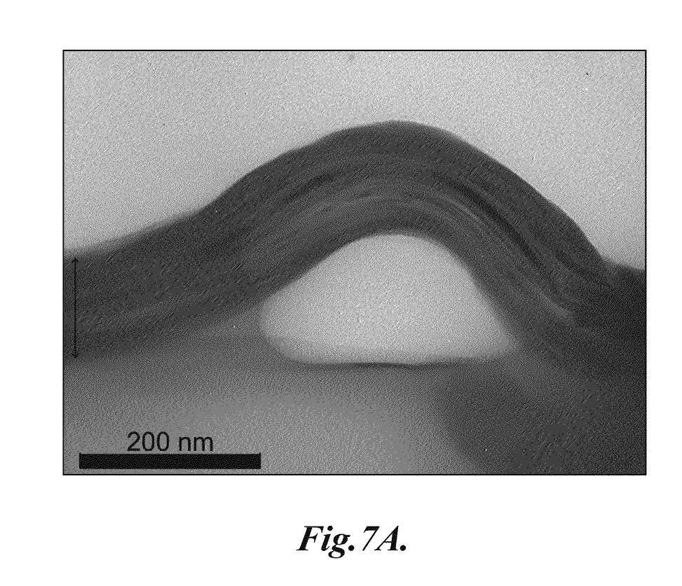

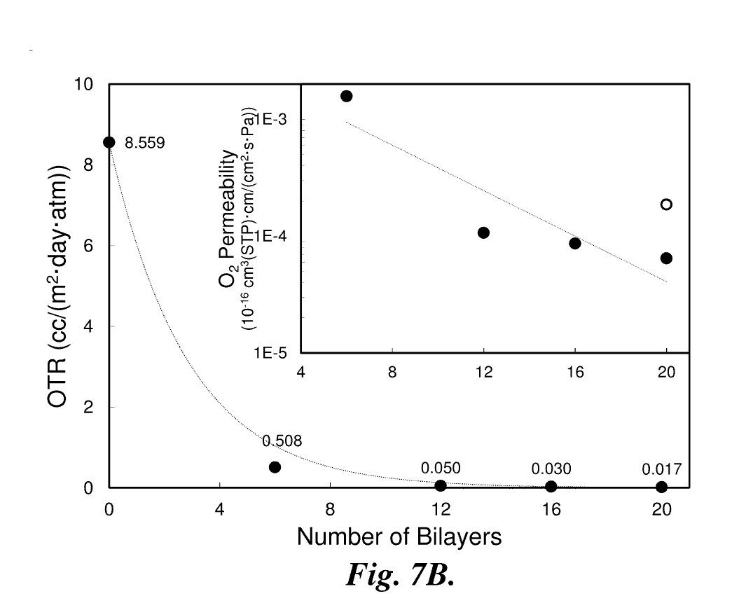

The exfoliation state of VMT in these films is clearly observed in the cross-sectional TEM image of a 12-bilayer film deposited onto PET, shown in FIG. 7A. Individually deposited vermiculite clay platelets can be seen in this image as dark, wavy horizontal lines, revealing the typical nanobrick wall structure exhibited by polymer/clay LbL films. The highly aligned structure seen in this micrograph also confirms that every platelet deposited in the film lays flat, with its largest dimension parallel to the substrate. These incredibly high levels of clay loading and exfoliation are only achievable by the self-assembling, self-terminating nature of the LbL assembly process.

FIG. 7B reveals that the OTR of these assemblies decreases exponentially as a function of bilayers deposited onto PET film. (A 6-bilayer film, only 48 nm thick, lowers the OTR by more than an order of magnitude, from 8.6 cc/(m²·day·atm) for bare PET to 0.5 cc/(m²·day·atm) at 0% RH, making it useful for food packaging and LED/LCD panel or photovoltaic device encapsulation. After 20 bilayers are deposited onto PET, this system exhibits super gas barrier properties, with an OTR of 0.017 cc/(m²·day·atm) at 0% RH. The inset in FIG. 7B reveals that the oxygen permeability of these films also decreases exponentially as a function of bilayers deposited, a phenomenon unique to these LbL thin films. While film thickness is increased by a factor of 3.4, from 6 to 20 bilayers, thin film permeability decreases by a factor of 25. More impressive is the OTR disparity of these same films, where OTR decreases by more than an order of magnitude from 6 to 20 bilayers.

The super oxygen barrier of these thin film assemblies (summarized in Table 1) is believed to be due to the existence of a nanobrick wall structure, revealed in FIG. 7A, that creates a tortuous pathway for permeating gas molecules. While diffusing through the thin film assembly, gas molecules must travel around individually deposited (or stacks of just a few) VMT platelets, which significantly extends the diffusion length traveled. This larger residence time of a permeating molecule in the film's thickness yields a lower rate of gas permeation. When compared to a previously reported thin film of PEI/MMT, the films of the invention utilize vermiculite clay that has an aspect ratio that is an order of magnitude larger than MMT and is shown to deposit more clay in the thin film (92 vol % VMT as compared to 83 vol % MMT), as shown in Table 1. This combination of larger aspect ratio and higher clay concentration results in a 20-bilayer VMT-based film to exhibit an OTR that is a factor of 3 lower than the same film made with MMT. In addition, as seen in Table 1, this simple alteration of clay platelet choice is capable of improving the barrier improvement factor (BIF, uncoated PET permeability divided by the coated permeability) by a factor of 5, where 20 bilayers of PEI/VMT yield a BIF of 500, as compared to 110 for films made with MMT

TABLE 1
Volume Fraction of Clay, OTRs, and BIF of Films Deposited
on 179 μm PET

| | | | Oxygen | | |
|---|---|---|---|---|---|
| | | | Permeability | | |
| | | | (10⁻¹⁶ cm³ | | |
| | Volume | OTR | (STP) · cm/ | | |
| Thin Film | Fraction | (cm³/m² · | (cm² · s · Pa)) | | BIF |
| Assembly | Clay (φ) | day · atm) | Coating^{a} | Total | (P_{S}/P_{T}) |
| 179 μm PET | — | 8.559 | — | 17.50 | — |
| (PEI/VMT)₂₀ | 0.92 | 0.017 | 0.000064 | 0.035 | 500 |
| (PEI/MMT)₂₀ | 0.83 | 0.078 | 0.00019 | 0.16 | 110 |

^{a}Coating permeability was decoupled from the total using the method described in Roberts, A. P.; Henry, B. M.; Sutton, A. P.; Grovenor, C. R. M.; Briggs, G. A. D.; Miyamoto, T.; Kano, A.; Tsukahara, Y.; Yanaka, M. J Membrane Sci 2002, 208, 75-88.

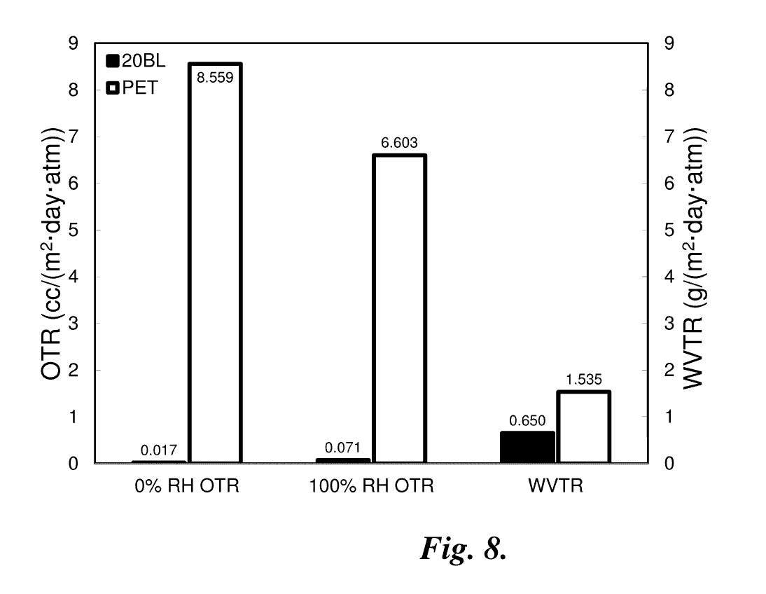

The OTR values in Table 1 were measured under dry conditions (0% RH), but it is well known that LbL film properties degrade under elevated humidity. Oxygen barrier performance under humid conditions was evaluated by testing the OTR of a 20-bilayer film deposited onto PET at 100% RH. FIG. 8 shows that the oxygen transmission rates of the 20BL film increases as a function of relative humidity, however this increase is much less than that reported previously for MMT-based thin films. The 20BL coating exhibits a decrease in barrier by a factor of 4 when exposed to 100% RH. This is in stark contrast to the polymer/clay coatings previously reported, which suffered orders of magnitude increases in OTR when exposed to similar humidity levels. The improvement at higher RH is believed to be due to the lower moisture absorption of the clay.

LbL gas barrier films have also been mostly tested for their low permeability to oxygen gas, with water vapor transmission rates (WVTR) generally left untested. This 20BL coating was deposited on PET, which has a WVTR of approximately 1.5 g/(m²·day) at 100% RH, and exhibited a WVTR improvement of 57% (FIG. 8). This large improvement in water vapor barrier is impressive for films created from dilute, aqueous mixtures and is believed to be due to the tightly-packed, highly-aligned nanobrick wall structure (FIG. 7A) comprised of 96.6 wt % VMT and the low moisture absorption characteristics of VMT. These factors lead to films that are less sensitive to humidity and impart more than a factor of two water vapor barrier improvement on 179 μm PET, at a thickness of less than 165 nm.

In conclusion, vermiculite clay was deposited successfully, for the first time in an LbL film, alongside polyethylenimine. Film growth measured on a silicon wafer demonstrates a linear growth rate of approximately 8 nm per bilayer, while deposition onto quartz glass sides reveals that a 20-bilayer film remains 95% transparent with 96.6 wt % clay. When deposited onto 179 μm PET film, this 20-bilayer nanocoating exhibits an OTR an order of magnitude less than that for a similar coating produced with MMT clay, yielding a barrier improvement factor of 500. These films also exhibit a less humidity-sensitive oxygen barrier and improve the WVTR of PET by over 50%. At only 164 nm thick, this completely transparent and highly flexible film is among the best polymer/clay nanocomposites ever reported for gas barrier, and represents an inexpensive, relatively simple alternative to inorganic layers for a variety of packaging applications.

The present invention provides thin films that are transparent, a barrier to gases, and moisture resistant. In one embodiment, large aspect ratio vermiculite (VMT) clay into the thin films, which are fabricated using the layer-by-layer assembly technique. Thin films of branched polyethylenimine (PEI) and VMT were analyzed for their growth rate, clay composition, transparency, and gas barrier behavior. In certain embodiments, the films include more than 96 wt % clay, are greater than 95% transparent, and, due to their nanobrick wall structure, exhibit super gas barrier behavior at thicknesses less that 165 nm. When coupled with their flexibility, optical clarity, and super barrier properties, these films are effectively used as coatings for a variety of packaging applications.

Embodiments of the present disclosure concern multilayer films that are effective barriers for humidity and oxygen, articles of manufacture that include the films, and methods for making and using the films.

In the embodiments disclosed herein, layer-by-layer assembly (LbL) is used to successfully impart numerous beneficial properties to surfaces, such as oxygen barrier, flame retardancy, and electrical conductivity. LbL-assembled thin films made with polyelectrolytes and clay can act as gas barrier layers for a variety of food, pharmaceutical, and electronics applications.

In these embodiments, each layer is very thin; accordingly, many bilayers are typically used to achieve a desired property. Further, in the embodiments of the disclosure, by lowering the pH of the clay solution used for deposition during layer-by-layer assembly, more clay is deposited every layer. The lowered pH causes greater clay deposition per layer due to tighter packing and stacking of nanoplatelets.

Moreover, in the LbL deposition process, the pH of solutions is routinely altered by adding small amounts of acid or base. In this case, HCl (or another acid) is added to the clay suspension until the desired pH is attained. This method can be applied to any number of coatings where a particle or platelet's charge is not strongly affected by the pH of its environment.

In certain embodiments herein wherein the pH is lowered, polyethyleneimine (PEI)/montmoroillonite (MMT) clay bilayer (BL) systems are used to increase thickness compared to using unaltered clay suspensions. In these embodiments, high oxygen barrier performance is achieved by the use of fewer layers which are thicker. As an example, the barrier of a 10 BL film with altered clay suspension pH outperforms that of a 15 BL film constructed with unaltered clay. Notably, in the embodiments disclosed herein, the pH of the clay suspension does not alter the charge of the clay platelets, but, instead, the charge of the previously deposited polymer layer. The embodiments disclosed herein improve the efficiency in which films are deposited on a substrate by obtaining a high barrier with fewer layers. This concept could be extended to other clay-containing films with any number components per cycle, such as quadlayers and hexalayers.

As a non-limiting example, without altering the pH of the MMT suspension, 15 bilayers are required to achieve an oxygen transmission rate of 0.175 cc/m²·atm·day, while films grown at pH 4 require only 10 bilayers to achieve 0.148 cc/m²·atm·day (see attached document for more detail about gas barrier results). This also provides a barrier at 10 BL that is 82% lower than that of a 10 BL film constructed with unaltered clay. This improvement to the layer-by-layer process is an important step in creating commercially-viable films.

In one embodiment of the disclosure, a coated structure is provided. The coated structure comprises a substrate having a surface and a coating substantially covering the surface. In one embodiment, the coating comprises: (a) a first layer comprising a polycation, a polyanion, or a polar, non-ionic, water-soluble polymer; and (b) a second layer comprising a clay platelet. In the practice of the layer-by-layer process of the disclosure, coatings are formed by sequential deposition of layers. The deposition of materials making up a new layer onto the deposited materials making up an existing first layer can result in the materials of the new layer penetrating the material of the existing layer to provide a region in the coating where the materials of the new and existing layers are mixed. The extent and depth of the mixing between adjacent layers will depend on the nature of the materials and the deposition process. In certain embodiments, it will be appreciated that interaction between layers exist and that the interaction can range from an interface between the two layers to a zone between the two layers in which materials from adjacent layers are highly interdiffused rather than discrete layers.

When the platelet is applied directly to the substrate surface (i.e., the second layer is intermediate between the surface and the first layer), there is an association between the surface and the platelet sufficient to provide a stable coated structure. The association can be an electrostatic association where the platelet has a net negative charge and the surface has a net positive charge, or, alternatively, the platelet has a net positive charge and the surface has a net negative charge. The association can be based on polarity where the platelet has a polarity opposite that of the surface. The associate can be based on hydrogen bonding between the platelet and the substrate surface.

In one embodiment, the coated structure includes only a first layer and a second layer as described above and the coating is a bilayer. A schematic illustration of a representative bilayer coating of the disclosure is illustrated in FIG. 1. Referring to FIG. 1, representative structure 100 includes substrate 110 having first layer 120 that is coextensive with a surface of the substrate, and second layer 130 that is coextensive with a surface of the first layer. Structure 100 includes substrate 110 and bilayer 350.

The coated structures of the disclosure include at a minimum the first and second layers. It will be appreciated that a great variety of coated structures can be readily prepared by the layer-by-layer process described herein. Beyond the first and second layers described above, the number and nature of layers in a coated structure of the disclosure can be widely varied provided that adjacent layers have an association sufficient to provide a stable coating.

In one embodiment, the coated structure is a quadlayer. A schematic illustration of a representative quadlayer coating of the disclosure is illustrated in FIG. 2. Referring to FIG. 2, representative structure 200 includes substrate 210 having first layer 220 that is coextensive with a surface of the substrate, second layer 230 that is coextensive with a surface of first layer 220, third layer 240 that is coextensive with a surface of second layer 230, and fourth layer 250 that is coextensive with a surface of third layer 240. Structure 200 includes substrate 210 and quadlayer 450.

In other embodiments, the present disclosure provides coated structures comprising the bilayers and quadlayers described herein.

In one embodiment, multi-bilayer-coated structures are provided. In this embodiment, the coated structure comprises:

(a) a substrate having a surface; and

(b) a coating substantially covering the surface, the coating comprising a plurality of alternating first and second layers, wherein

(i) the first layer comprises a cationic polymer; and

(ii) the second layer comprises an anionic clay platelet suspension.

In a further embodiment, a multilayer film is prepared and the above method further includes repeating steps (g) through (l) n times, where n is an integer from 1 to 30. This embodiment is effective to provide an n x bilayer coating.

A representative bilayer coating includes a first layer comprising a polyethylenimine and a second layer comprising a clay, such as vermiculite or montmoroillonite.

As noted above, the number and nature of layers in the coating of the coated structures of the disclosure can be widely varied. Thus, in certain embodiments, the disclosure provides a coated structure, comprising: (a) a substrate having a surface; (b) a coating substantially covering the surface, the coating comprising a plurality of layers, and wherein each layer comprises (i) a cationic polymer or (ii) an anionic clay platelet suspension.

In certain embodiments, a multilayer film is prepared and the above method further includes: optionally rinsing the coated surface; optionally drying the coated surface; contacting the coated surface with a fourth solution comprising a platelet having a water content of less than 7% to provide a platelet coated surface; optionally rinsing the platelet coated surface; and optionally drying the platelet coated surface.

In the above methods, contacting can include dip coating, spray coating, roll coating, or printing.

In the above methods, the product coated structure is dried, typically by subjecting the coated structure to elevated temperature (e.g., 70° C.) for a period of time (e.g., 15 min.)

In the above methods, the solvent for the polycation, polyanion, or polar, non-ionic, water-soluble polymer can be deionized water; the solvent for the platelet can be deionized water, and rinsing can include rinsing with deionized water.

In certain embodiments, the coated structures of the disclosure include a coating that includes a polycation. A used herein the term “polycation” refers to a polyelectrolyte having an overall positive charge or that can become positively charged depending on the pH of the environment (e.g., protonation of an amine group at lower pH). Representative polycations include linear polyethylenimine (LPEI), branched polyethylenimine (BPEI), poly(allyl amine), poly(vinyl amine), cationic polyacrylamide, cationic polydiallyldimethylammonium chloride (PDDA), polymelamine and copolymers thereof, polyvinylpyridine and copolymers thereof, and combinations thereof.

In certain embodiments, the coated structures of the disclosure include a coating that includes a polar, non-ionic, water-soluble polymer. A used herein the term “polar, non-ionic, water-soluble polymer” refers to a polymer that is polar (i.e., includes atoms having differing electronegativities), non-ionic (i.e., no charge), and is substantially water soluble. Representative polar, non-ionic, water-soluble polymers include polyalkylene oxide polymers (e.g., polymers and copolymers of ethylene oxide and propylene oxide), polyvinylpyrrolidone polymers, and polyvinyl alcohol polymers, and combinations thereof.

The coated structures of the disclosure include a platelet. Suitable platelets include naturally occurring inorganic materials (e.g., clays and minerals) and synthetic materials. Representative platelets include minerals such as montmoroillonite, vermiculite, and mica; zirconium phosphate, and graphenes including graphene oxide and surface modified graphenes.

For the coated structures of the disclosure, the substrate can be any suitable substrate having a surface that benefits from the barrier that the coating provides. Suitable substrates include sheets, films, and fibers. In certain embodiments, the substrate is polymeric. Suitable polymers include polyesters, polyamides, polyimides, polyolefins, and vinyl polymers. Representative polyesters include polyethylene terephthalate, polyethylene naphthalate, polylactic acid, polybutylene succinate, polyglycolic acid, and polyhydroxyalconates. Representative polyamides include nylons. Representative polyolefins include polyethylenimine, polyethylene, polypropylene, polyethylene vinyl acetate, maleic anhydride grafted polyethylene, polyethylene acrylic acid. Representative vinyl polymers include polystyrene and polyvinyl chloride. Combinations of polymers are also suitable.

Suitable substrates that can be advantageously coated in accordance with the disclosure include substrates having more than one surface (e.g., a film having two major surfaces). The surfaces of such substrates can be selectively coated. Coated structures of the disclosure include structures having more than one coated surface (e.g., both major surfaces of a film).

Suitable substrates also include laminated polymeric substrates and co-extruded substrates. A laminated substrate includes two or more adhered polymeric materials (e.g., first polymer substrate|adhesive|second polymer substrate|adhesive|third polymer substrate). A co-extruded polymeric substrate is a substrate formed by co-extrusion of a multiple polymers.

In addition to synthetic polymeric substrates, suitable substrates include cellulosic substrates such as paper, fabrics, and textiles.

The substrates that are advantageously coated included substrates having formed surfaces (i.e., surfaces that on a macroscopic level are not flat).

The coated structures of the disclosure can be subjected to additional treatments that further enhance the advantageous properties of these structures. Representative treatments include chemical cross-linking. Intermediate layers formed during the preparation process can be subject to additional treatment (e.g., cross-linking) to enhance the properties of the product coated structure.

To facilitate the advantageous properties achieved by the coating of the structures of the disclosure, the platelet has an average aspect ratio from about 100 to about 20,000. In certain embodiments, the platelet has an average aspect ratio from about 200 to about 10,000. In some embodiments, the average aspect ratio is greater than 100; in other embodiments, greater than 500; in further embodiments, greater than 700; and in yet other embodiments, greater than 900. As used herein, the term “aspect ratio” refers to the ratio of platelet thickness to platelet diameter. Because platelet thickness is about 1 nm, the aspect ratio is the platelet diameter. “Average aspect ratio” refers to the average ratio for platelets in the layer.

To facilitate the advantageous properties achieved by the coating of the structures of the disclosure, the platelet has a water content of less than 7% by weight based on the total weight of the platelet, preferably less than about 5%, and more preferably less than about 3%. In certain embodiments, the platelet has a water content from about 0.5 to about 5% by weight. In other embodiments, the platelet has a water content from about 1 to about 3% by weight.

The coating of the structures of the disclosure can include layers of varying thickness. The layers in a coating can be substantially the same (i.e., within 5 or 10% of each other) or the thickness may differ from layer to layer. Representative layer thickness ranges from about 1 to about 100 nm.

In certain embodiments, the structures of the disclosure have coating that are substantially transparent (e.g., greater than 90% transmission at visible wavelengths, 390 to 750 nm).

The coatings impart an advantageous average oxygen transmission rate (OTR) to the coated structures. The rates are generally dependent on the nature and number of layers. In certain embodiments, the coated structures have an average oxygen transmission rate less than about 5 cc/(m²day atm), preferably less than about 1.5 cc/(m²day atm), and more preferably less than about 1.0 cc/(m²day atm). Certain coated structures of the disclosure have undetectable average oxygen transmission rates (<0.005 cc/(m²day atm). In certain embodiments, the coated structures have an average oxygen transmission rate of from about 0.005 to about 5 cc/(m²day atm). In other embodiments, the coated structures have an average oxygen transmission rate of from about 0.005 to about 1.5 cc/(m²day atm). In further embodiments, the coated structures have an average oxygen transmission rate of from about 0.005 to about 1.0 cc/(m²day atm).

In another aspect, the disclosure provides articles of manufacture that include the coated structures of the disclosure. Representative articles include packaging material, for example for food and pharmaceuticals; display devices such as electronic devices, organic light emitting diodes, and touchscreen surfaces.

In a further aspect of the disclosure, methods for making coated structures are provided. The methods are referred to layer-by-layer methods because each layer of the coating is formed on a previously formed layer.

The following examples are provided for the purpose of illustrating, not limiting, the invention.

### EXAMPLE

The following examples are included to demonstrate preferred embodiments of the disclosure. It should be appreciated by those of skill in the art that the techniques disclosed in the examples which follow represent techniques discovered by the inventor to function well in the practice of the disclosure and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### Example 1

In this example, the preparation and characteristics of a representative coated structure of the invention is described.

Thin Film Materials. Specialty Vermiculite Corp. (Cambridge, Mass.) supplied the natural vermiculite (VMT) (Microlite 963++) clay dispersion. Branched polyethylenimine (PEI) (Mw=25,000 g/mol, Mn=10,000 g/mol) was purchased from Sigma-Aldrich (Milwaukee, Wis.). Aqueous, 0.1 wt % PEI solutions were prepared using 18.2 MΩ deionized water and rolling for 24 hours. Prior to deposition, each PEI solution's pH was altered to 10 using 1M HCl. Aqueous suspensions of VMT (2 wt % in deionized water) were prepared 48 hours before use by rolling for 24 hours and allowing for sedimentation of insoluble fractions for the remaining 24 hours. The unaltered supernatant was used and measured to be pH 7.5, 2 wt % VMT, and have an average effective diameter of 1.1 μm.

Substrates. Single-side-polished, silicon wafers, purchased from University Wafer (South Boston, Mass.), were used as substrates to monitor film growth via ellipsometry. One millimeter thick, fused quartz slides, purchased from Structure Probe, Inc. (West Chester, Pa.), were used as substrates to monitor light transmission via UV-vis spectrometry. Silicon wafers, cut to approximately 4 in.×1 in. strips, and 3 in.×1 in. quartz slides, were cleaned with piranha solution for 30 minutes, rinsed with deionized water, acetone, and water again, and dried with filtered air prior to deposition. Polished Ti/Au crystals with a resonance frequency of 5 MHz, purchased from Maxtek, Inc. (Cypress, Calif.), were used as substrates to monitor mass deposition via quartz crystal microbalance (QCM). QCM crystals were plasma cleaned in a PDC-32G plasma cleaner from Harrick Plasma (Ithaca, N.Y.) for 5 min at 10.5 W prior to deposition. 179 μm thick Melinex® ST505 poly(ethylene terphthalate) film (PET), produced by Dupont-Teijin Films, and purchased from Tekra (New Berlin, Wis.), was used as the substrate for OTR testing and TEM images. PET was rinsed with deionized water, methanol, water again, dried with filtered air and finally corona treated using a BD-20C Corona Treater (Electro-Technic Products, Inc., Chicago, Ill.) prior to deposition.

Thin Film Deposition. Treated substrates were dipped in the PEI solution for 5 min, rinsed in a stream of deionized water, and dried in a stream of filtered air. This procedure was followed by an identical dipping, rinsing and drying procedure in the VMT suspension. After this initial bilayer was deposited, the same procedure was followed with 5 s PEI and 1 min VMT dip times for each subsequent layer until the desired number of layers were deposited. All thin films were prepared using a robotic dipping system described in Jang, W. S.; Grunlan, J. C. Rev Sci Instrum 2005, 76; and Gamboa, D.; Priolo, M. A.; Ham, A.; Grunlan, J. C. Rev Sci Instrum 2010, 81. Films created for OTR testing were placed in an oven at 70 OC for 15 min immediately following deposition.

Characterization Techniques. Film thickness was measured (on silicon wafers) using an alpha-SE Ellipsometer (J.A. Woollam Co., Inc., Lincoln, Nebr.). Mass deposition was measured (on Ti/Au crystals) using a Research Quartz Crystal Microbalance (Maxtek, Inc., Cypress, Calif.). Film absorbance was measured (on quartz glass slides) using a USB2000 UV-vis spectrometer (Ocean Optics, Dunedin, Fla.). A thin film cross section was imaged using a JEOL 1200 EX (Peabody, Mass.) TEM at an accelerating voltage of 100 kV and calibrated magnifications. A 12 BL thin film was deposited on PET, coated with carbon, and embedded in epoxy prior to sectioning. Thin sections (about 100 nm thick) were floated onto water and picked up using carbon-stabilized, Formvar-coated 150 mesh nickel grids (Electron Microscopy Sciences, Hatfield, Pa.) in preparation for imaging. OTR and WVTR was measured (on 179 μm thick PET), and performed by MOCON (Minneapolis, Minn.), using an Oxtran 2/21 ML Oxygen Permeability Instrument (in accordance with ASTM D-3985) at 23° C. and at 0% and 100% RH and a Permatran-W 3/33 Water Vapor Permeability Instrument (in accordance with ASTM F-1249) at 23° C. and 100% RH. VMT particle size was determined using a ZetaPALS (Zeta Potential Analyzer Utilizing Phase Analysis Light Scattering) system from Brookhaven Instruments Corporation (Holtsville, N.Y.).

While the preferred embodiment of the invention has been illustrated and described, it will be appreciated that various changes can be made therein without departing from the spirit and scope of the invention.

### Example 2

### Effect of Clay Suspension pH on Nanobrick Wall Thin Film for Improved Gas Barrier

Introduction

Layer-by-Layer deposition is a simple, cost effective, and versatile processing technique used to create functional thin film composites with outstanding properties on almost any substrate. 1-2 Thin films have been created using LbL that passively block gas3 and heat,4 respond to light,5 heat,6 and pH7 in various ways, conduct electricity,8 and release pharmaceuticals.9 These are some of the few applications in mind when new thin film composites are developed, but the applications are endless. Layer-by-Layer is the process of depositing species with complementary functionality, electrostatic interaction being the most extensively studied driving force.2 As long as these functionalities are present (inherent or imparted) various shapes such as dots,10 rods, 11 tubes,12 sheets,8 platelets,13 and spheres 14 can be utilized to create specific structures one nano-layer at a time. Any even numbered sequence can be used to build up films with specific purposes for various sections within the film. Even sequences of three or more can be used if multiple functionalities15 or reinforcement of a previous layer16 is employed. Beyond materials used, there are many parameters that can be altered during deposition to further tailor the final thin film morphology such as concentration, pH, solution temperature, ionic strength, charge density, molecular weight, and polymer chain architecture.2

In the LbL literature, studies have been performed examining the effect of polyelectrolyte solution pH on the resultant thin film growth rate and morphology. 17-20 In addition to changing the charge density and resultant configuration of the polymer in that solution, altering one solution pH will also affect the charge density of the exposed polymers chains of the previously deposited layer.21-23 The purpose of this study is to show that by altering pH environment of the clay suspension the amount of clay platelets deposited can be controlled. The surface charge of montmoroillonite (MMT) platelets does not dramatically change with regard to suspension pH. Altering the pH of the clay solution does not primarily affect the MMT platelets, but more so, the previously deposited PEI layer. PEI is very highly charged at low pH and has only a slight charge at high pH.24 PEI is deposited at pH 10 because it assumes a coiled conformation due to minimal self-repulsion at the low charge state, causing a thick layer to deposit. At low pH the deposited PEI becomes highly charged, allowing more clay to be deposited. A clear increase in the thickness of PEI/MMT bilayers (BL) as the MMT suspension pH is reduced is shown in FIG. 1b, and the increased clay content leads to exceptional performance as oxygen barrier thin film. These nanobrick wall structures, clay structure with polymeric mortar, also exhibit flexibility and high transparency that are desirable in barrier applications for food packaging, flexible electronics, and pressurized bladders.25-27 Traditional barrier layers like metallized plastic or inorganic oxides, SiOₓ and AlₓO_{y}, require complex processing environments and are prone to cracking and pinholes.28-29 The polymer-clay nanocomposites thin films explored here are a viable option for reducing the amount of material used (120 nm thin) while providing a more aesthetic (transparent) solution.

Materials

Branched polyethylenimine (PEI) (M_{w}=25,000 g/mol, ρ=1.10 g/cm³) was purchased from Sigma-Aldrich and used as a 0.1 wt % DI water solution. Natural sodium montmoroillonite clay (trade name Cloisite NA+) provided by Southern Clay Products, Inc. (Gonzales, Tex.), was dispersed as a 1 wt % suspension in deionized (DI) water by rolling solutions in bottles overnight. MMT platelets have a reported density of 2.86 g/cm³, diameter ranging from 10-1000 nm, and thickness of 1 nm.30 Zeta potential of MMT suspensions was measured with a Zeta Phase Angle Light Scattering (ZETA PALS) (Brookhaven Instruments Corporation, Holtsville, N.Y.).

Substrates

Polyethylene terephthalate (PET) film, with a thickness of 179 μm (trade name ST505, produced by Dupont-Teijin), was purchased from Tekra (New Berlin, Wis.) and used as the substrate for oxygen transmission rate (OTR) testing and transmission electron microscopy (TEM). This PET film has an OTR of approximately 8.6 cm3/(m2·day·atm) under dry conditions. Prior to deposition, PET substrates were rinsed with DI water, methanol, and then DI water, followed by treatment of each side of the substrate using a BD-20C Corona Treater (Electro-Technic Products, Inc., Chicago) to ensure an adequate negative surface charge before coating. Polished silicon wafers, purchased from University Wafer (South Boston, Mass.), were used as substrates for profilometry and atomic force microscopy (AFM). Silicon wafers were rinsed with DI water, acetone, and DI water and then plasma treated for five minutes immediately before use. Thin films to be used under Thermogravimetric Analysis (TGA) were deposited onto Polytetrafluoroethylene (PTFE) sheets purchased from McMaster Carr (Elmhurst, Ill.). The PTFE sheets were rinsed with ethanol and water, but were not treated, allowing a weaker surface adhesion.

Layer-by-Layer Assembly

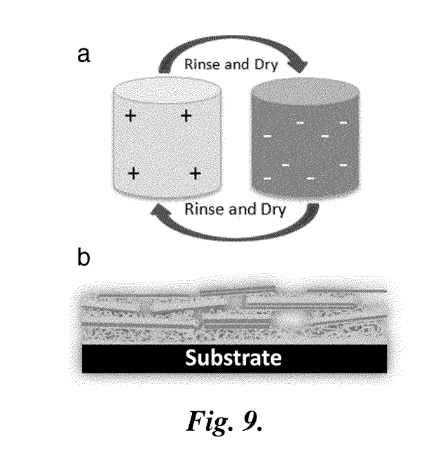

Each substrate was dipped into the cationic 0.1 wt % PEI solution (adjusted to pH 10.0 using 1 M HCl) for one minute. After this, and every subsequent dip, the substrate was rinsed with DI water and dried with filtered air. The substrate was then dipped into a 1% anionic MMT clay suspension for one minute, (adjusted using 1M HCL) which completed a single bilayer (BL) dipping cycle, as illustrated in FIG. 9. This process was repeated until x bilayers was obtained, written [PEI/MMT_{y}]ₓ, where y denotes MMT suspension pH. After the final rinsing and air drying, the films deposited on PET were dried in an oven at 70° C. for 15 min.

Film Characterization

Thickness data were taken as a function of bilayers deposited with a P6 profilometer (KLA-Tencor, Milpitas, Calif.). Multiple scratches were made at each position so that height from the leveled substrate could be measured, and each data point reported is an average of values measured from three wafers. Mass deposition onto Ti/Au plated quartz crystals was measured using a Research Quartz Crystal Microbalance (QCM) (Maxtek Inc., Cypress, Calif.) by measuring the resonant frequency value of the crystal after every drying step. Atomic force microscopy data (AFM) was acquired using a Dimension Icon AFM (Bruker, Billerica, Mass.) in tapping mode with an HQ:NSC35/Al BS probe (Mikromasch, Lady's Island, S.C.). Root mean square roughness (R_{q}) measurements were taken from a 20 μm×20 μm area. TGA data was collected using a Q50 Thermogravimetric Analyzer (TA Instruments, New Castle, Del.). 200 BL films on PTFE substrates were soaked in DI water overnight and scraped off using a razor blade in a sweeping motion to ensure the substrate was not scraped off with the film. The film was heated at 10° C./min to 120° C. and held for an hour to remove all excess moisture. The film was then heated at the same rate to 650° C. and held for an hour. Clay concentration was calculated as the mass remaining at the end of the test divided by the mass at the end of the 120° C. holding period. OTR testing was performed according to ASTM D-3985 specifications by MOCON (Minneapolis, Minn.) using an Oxtran 2/21 ML instrument at testing conditions of 23° C. and 0% RH. Samples for TEM were prepared by embedding the film in Epofix (EMS, Hatfield, Pa.) resin overnight and cutting sections, using an Ultra 450 diamond knife (Diatome, Hatfield, Pa.) at a 60 angle, onto 300 mesh copper grids. TEM micrographs of the thin film cross sections (˜90 nm thick) were imaged using a Tecnai G2 F20 (FEI, Hillsboro, Oreg.) at an accelerating voltage of 200 kV.

Results and Discussion

Influence of pH on Film Growth

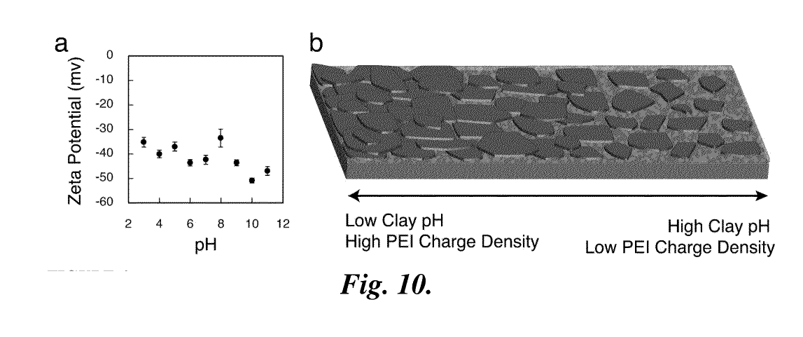

Using two polymers that alternately have low charge levels in their own solution pH and high charge when exposed to the pH condition of the other polymer allows for very thick growth due to a very high surface charge from the previously deposited polymer, which leads to a thick deposition of the following layer in order to satisfy the surface charge. This technique has primarily been used for weak polyelectrolytes, but the same theory can be used to increase the growth rate of a polymer/nanoparticle system, which was first demonstrated by using silicon nanoparticles.22 In the present study we use PEI at pH 10 and MMT at varying pH levels. From FIG. 10a it can be seen that the net zeta potential of MMT platelets in suspension is not highly dependent upon pH, where the Zeta potential remains between −30 and −50 mV in the pH 3-11 range, which is due to the dominating permanent negative charge of the MMT platelet basal planes of as a result of isomorphic substitutions.31 The amphoteric edge sites are positively charged below and negatively charged above pH 6.5, which only has small effect on the net zeta potential.31 The PEI charge density, however, is highly dependent upon pH.24 At pH 10 there is less than 5% protonation, but as the pH decreases, many of the amine groups become protonated, approximately 60% protonation at pH 4.24 In order to deposit more MMT clay platelets every deposition cycle, the pH of the clay suspension is reduced, which slightly changes the zeta potential of the clay, but more importantly, dramatically increases the charge density of the previously deposited PEI, shown schematically in FIG. 10b. This increase in charge density attracts more clay platelets to the surface, creating a thicker, more tortuous pathway through which oxygen (or other molecules) must diffuse.

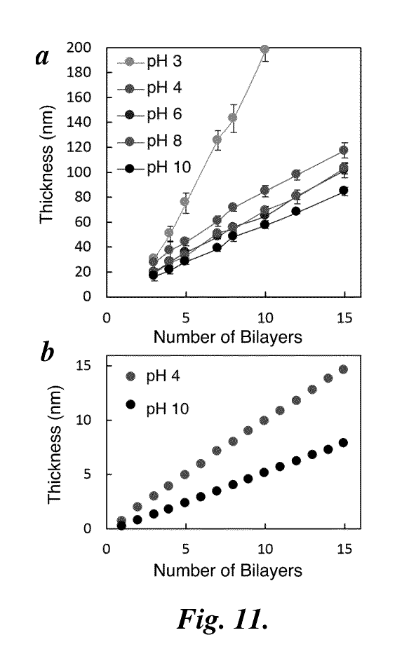

The PEIₓ/MMT_{9.7} (unaltered MMT solution) system was previously studied to examine the effect of pH on the PEI solution, where the thickest, and best oxygen barrier, was achieved at a high value of pH 10.20 The PEI₁₀/MMT_{9.7} system had a linear growth rate of approximately 3 nm/BL through 20 BL. The thickness values of PEI₁₀/MMTₓ are shown in FIG. 11a to be significantly greater as the pH of the MMT suspension decreases, due to an increased amount of MMT deposited. The thickness profile of PEI/MMT₈ and PEI/MMT₆ are essentially the same, while PEI/MMT₄ shows another increase in thickness. PEI/MMT3 shows a significant change in thickness, growing much more thickly. QCM Data reveals a significant increase in mass deposited for the lower pH clay system, shown in FIG. 11b. Clay concentration of the film could not be calculated using QCM due to instances where the total mass was reduced after the PEI deposition from desorption of some of the outermost clay platelets and replacement by PEI, which resulted in a net loss of mass after PEI deposition. Clay concentration was, however, calculated using TGA to be 77% for PEI/MMT₁₀ and 80% for PEI/MMT₄, an extremely high level of loading for both films when compared to conventional composites. There is an increase in clay concentration due to additional clay being added every deposition as the pH of the clay solution is reduced due to the PEI covered surface being highly charged, but the difference is hindered by additional PEI being deposited for the lower pH system. To see the full extent of this pH change on clay deposition, we calculate that the amount of clay added per bilayer increases from 0.42 to 0.79 μg/cm2, almost doubling the amount of clay added per bilayer simply by lowering the pH of the clay solution.

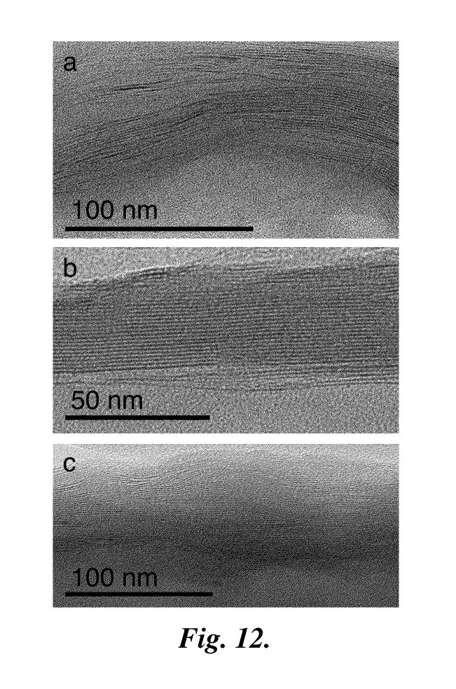

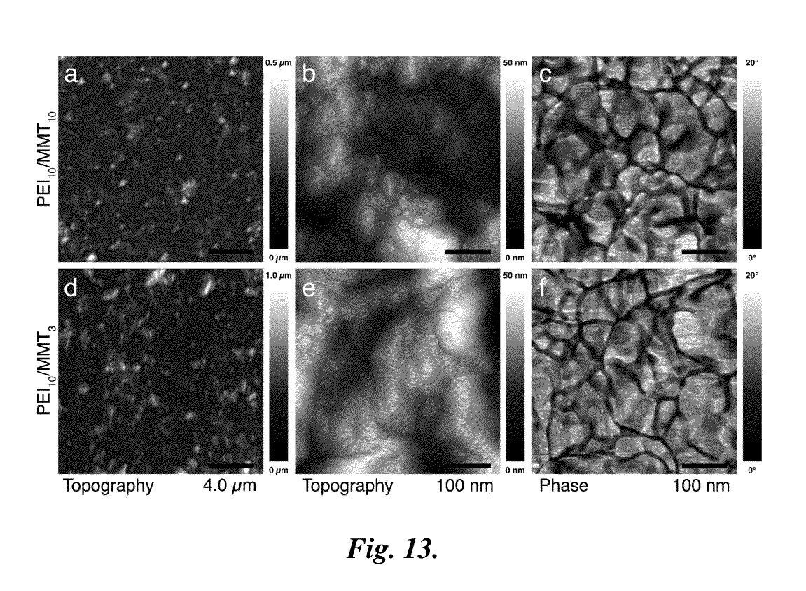

This high level of clay loading for the various films can be seen in the TEM images in FIG. 12. For MMT at pH 10, there are areas of highly ordered clay platelets and also areas of with gaps and what appear to be loose platelets. The PEI/MMT₄ system shows a very well ordered structure in the majority of the thin film, FIG. 10b. The PEI/MMT3 system shows some order, but there are many areas of misalignment within the tightly packed structure, potentially from a small amount of edge to face bonding within the MMT platelets. This does not happen readily in solution without the addition of indifferent electrolytes to shield opposing basal charges,31 but it is conceivable that this may sparsely occur in the highly confined packing of this film. At pH 3, the edges have a higher positive charge and can be attracted to the negatively charged face of the deposited MMT platelets. The AFM surface roughness values, R_{q}, are similar for the pH values of 4, 8, and 10 (˜30 nm) but for PEI₁₀/MMT₃, the surface roughness almost triples to 85 nm, which corresponds with the waviness observed in TEM micrographs. The AFM topography scans of the pH 10 (FIG. 13a,b) and pH 3 (FIG. 13d,e) appear similar at the 20 μm scan size (a,d) when the scale bars are set apart by a factor of 2. At a scan size of 500 nm, the features are similar, and the surfaces appear smooth without visible platelet edges. The phase images, however, highlight the cobblestone path structure of the top layer with many platelets visible in the 100-200 nm range. Uninterrupted platelets as large as 800 nm were observed in the pH 3 system using a larger scan size, not shown.

Oxygen Permeability

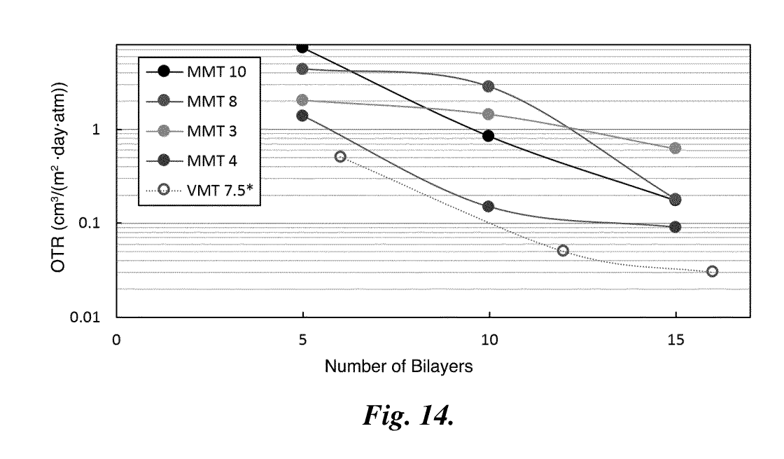

There are many interesting trends in OTR for these films as the pH of the MMT suspension is decreased. For PEI/MMT₈, there is no improvement over PEI/MMT₁₀ beyond 5 BL. At pH 4, there is over a 5× improvement in OTR as compared with the pH 10 clay system for the 5 and 10 BL, shown in FIG. 14. The effective permeability (calculated using previously a described method)32 of the [PEI/MMT₄]₁₀ film is 2.9×10-20·cm³ cm/(cm²·s·Pa), which is less than half the permeability reported for fully inorganic SiOₓ coatings.33 [PEI/MMT₄]₁₅ has an OTR of 0.9 cm³/(m²·day·atm), 2 orders of magnitude improvement over the 3 orders of magnitude thicker PET substrate. The OTR performance of this system approaches that of PEI/vermiculite (VMT) bilayers reported in another study; VMT is a clay platelet that has an aspect ratio approximately one order of magnitude larger than MMT. 34 Larger aspect ratio clay creates a more tortuous pathway for gas molecules to take through the film, causing a lower transmission rate. By altering the pH of the MMT solution, we have increased the clay loading significantly, causing it to have the performance of a much higher aspect ratio clay platelet. The pH 3 system shows improved performance at 5 BL, but is a poorer barrier than PEI¹⁰/MMT¹⁰ at 10 and 15 BL. This is probably due to the large amount of material deposited quickly, providing decent barrier improvement over the substrate initially, but as the PEI¹⁰/MMT¹⁰ grows thicker, the more ordered structure provides a better tortuous path than the thick growing PEI₁₀/MMT₃ system which is very rough and highly disordered, as observed in TEM and AFM. Alignment of the clay platelets is crucial for creating the best barrier films because they cause oxygen molecules to travel laterally through the film instead of through the thickness.

The disclosure can be embodied in other specific forms without departing from its spirit or essential characteristics. A person of skill in the art should consider the described embodiments in all respects only as illustrative and not restrictive. The scope of the disclosure is, therefore, indicated by the appended claims rather than by the foregoing description. A person of skill in the art should embrace, within their scope, all changes to the claims which come within the meaning and range of equivalency of the claims. Further, we hereby incorporate by reference, as if presented in their entirety, all published documents, patents, and applications mentioned herein.

From the foregoing description, one of ordinary skill in the art can easily ascertain the essential characteristics of this disclosure, and without departing from the spirit and scope thereof, can make various changes and modifications to adapt the disclosure to various usages and conditions. For example, we do not mean for references such as above, below, left, right, and the like to be limiting but rather as a guide for orientation of the referenced element to another element. A person of skill in the art should understand that certain of the above-described structures, functions, and operations of the above-described embodiments are not necessary to practice the present disclosure and are included in the description simply for completeness of an exemplary embodiment or embodiments. In addition, a person of skill in the art should understand that specific structures, functions, and operations set forth in the above-described referenced patents and publications can be practiced in conjunction with the present disclosure, but they are not essential to its practice.

### REFERENCES

(1) Decher, G.; Schlenoff, J. B., Multilayer Thin Films. Wiley-VCH Verlag GmbH & Co. KGaA Weinheim, Germany, 2012.
(2) Borges, J.; Mano, J. F., Molecular Interactions Driving the Layer-by-Layer Assembly of Multilayers. Chem. Rev. 2014, 114, 8883-8942.
(3) Hagen, D. A.; Foster, B.; Stevens, B.; Grunlan, J. C., Shift-Time Polyelectrolyte Multilayer Assembly: Fast Film Growth and High Gas Barrier with Fewer Layers by Adjusting Deposition Time. ACS Macro Lett. 2014, 663-666.
(4) Cain, A. A.; Plummer, M. G.; Murray, S. E.; Bolling, L.; Regev, O.; Grunlan, J., Iron-containing, High Aspect Ratio Clay as Nanoarmor that Imparts Substantial Thermal/Flame Protection to Polyurethane with a Single Electrostatically-deposited Bilayer. J. Mater. Chem A 2014.
(5) Borges, J.; Rodrigues, L. C.; Reis, R. L.; Mano, J. F., Layer-by-Layer Assembly of Light-Responsive Polymeric Multilayer Systems. Adv. Funct. Mater. 2014, 24, 5624-5648.
(6) Zhou, J.; Pishko, M. V.; Lutkenhaus, J. L., Thermoresponsive Layer-by-Layer Assemblies for Nanoparticle-Based Drug Delivery. Langmuir 2014, 30, 5903-5910.
(7) Quadir, M. A.; Morton, S. W.; Deng, Z. J.; Shopsowitz, K. E.; Murphy, R. P.; Epps, T. H.; Hammond, P. T., PEG-Polypeptide Block Copolymers as pH-Responsive Endosome-Solubilizing Drug Nanocarriers. Mol. Pharmaceutics 2014, 11, 2420-2430.
(8) Stevens, B.; Dessiatova, E.; Hagen, D. A.; Todd, A. D.; Bielawski, C. W.; Grunlan, J. C., Low-Temperature Thermal Reduction of Graphene Oxide Nanobrick Walls: Unique Combination of High Gas Barrier and Low Resistivity in Fully Organic Polyelectrolyte Multilayer Thin Films. ACS Appl. Mater. Interfaces 2014, 6, 9942-9945.
(9) Ariga, K.; Kawakami, K.; Ebara, M.; Kotsuchibashi, Y.; Ji, Q.; Hill, J. P., Bioinspired nanoarchitectonics as emerging drug delivery systems. New J. Chem. 2014.
(10) Xiao, F. X.; Miao, J. W.; Liu, B., Layer-by-Layer Self-Assembly of CdS Quantum Dots/Graphene Nanosheets Hybrid Films for Photoelectrochemical and Photocatalytic Applications. J. Am. Chem. Soc. 2014, 136, 1559-1569.
(11) Placido, T.; Fanizza, E.; Cosma, P.; Striccoli, M.; Curri, M. L.; Comparelli, R.; Agostiano, A., Electroactive Layer-by-Layer Plasmonic Architectures Based on Au Nanorods. Langmuir 2014, 30, 2608-2618.
(12) Saetia, K.; Schnorr, J. M.; Mannarino, M. M.; Kim, S. Y.; Rutledge, G. C.; Swager, T. M.; Hammond, P. T., Spray-Layer-by-Layer Carbon Nanotube/Electrospun Fiber Electrodes for Flexible Chemiresistive Sensor Applications. Adv. Funct. Mater. 2014, 24, 492-502.
(13) Meaud, J.; Sain, T.; Yeom, B.; Park, S. J.; Shoultz, A. B.; Hulbert, G.; Ma, Z.-D.; Kotov, N. A.; Hart, A. J.; Arruda, E. M.; Waas, A. M., Simultaneously High Stiffness and Damping in Nanoengineered Microtruss Composites. ACS Nano 2014, 8, 3468-3475.
(14) Yanagida, S.; Kosakai, Y.; Yasumori, A., Preparation of gold nanoparticle dispersed TiO2-polymer composite film by a combined layer-by-layer and photocatalytic deposition method. Colloids Surf., A 2014, 456, 55-61.
(15) Lutkenhaus, J. L.; Olivetti, E. A.; Verploegen, E. A.; Cord, B. M.; Sadoway, D. R.; Hammond, P. T., Anisotropic Structure and Transport in Self-Assembled Layered Polymer-Clay Nanocomposites. Langmuir 2007, 23, 8515-8521.
(16) Hagen, D. A.; Box, C.; Greenlee, S.; Xiang, F.; Regev, O.; Grunlan, J. C., High gas barrier imparted by similarly charged multilayers in nanobrick wall thin films. RSC Advances 2014, 4, 18354-18359.
(17) Shiratori, S. S.; Rubner, M. F., pH-Dependent Thickness Behavior of Sequentially Adsorbed Layers of Weak Polyelectrolytes. Macromolecules 2000, 33, 4213-4219.
(18) Bieker, P.; Schönhoff, M., Linear and Exponential Growth Regimes of Multilayers of Weak Polyelectrolytes in Dependence on pH. Macromolecules 2010, 43, 5052-5059.
(19) Yoo, D.; Shiratori, S. S.; Rubner, M. F., Controlling Bilayer Composition and Surface Wettability of Sequentially Adsorbed Multilayers of Weak Polyelectrolytes. Macromolecules 1998, 31, 4309-4318.
(20) Priolo, M. A.; Gamboa, D.; Grunlan, J. C., Transparent Clay-Polymer Nano Brick Wall Assemblies with Tailorable Oxygen Barrier. ACS Appl. Mater. Interfaces 2010, 2, 312-320.
(21) Yang, Y.-H.; Haile, M.; Park, Y. T.; Malek, F. A.; Grunlan, J. C., Super Gas Barrier of All-Polymer Multilayer Thin Films. Macromolecules 2011, 44, 1450-1459.
(22) Peng, C.; Thio, Y. S.; Gerhardt, R. A.; Ambaye, H.; Lauter, V., pH-Promoted Exponential Layer-by-Layer Assembly of Bicomponent Polyelectrolyte/Nanoparticle Multilayers. Chem. Mater. 2011, 23, 4548-4556.
(23) Choi, J.; Rubner, M. F., Influence of the Degree of Ionization on Weak Polyelectrolyte Multilayer Assembly. Macromolecules 2004, 38, 116-124.
(24) Mészáros, R.; Thompson, L.; Bos, M.; de Groot, P., Adsorption and Electrokinetic Properties of Polyethylenimine on Silica Surfaces. Langmuir 2002, 18, 6164-6169.
(25) Graff, G. L.; Burrows, P. E.; Williford, R. E.; Praino, R. F., Barrier Layer Technology for Flexible Displays. In Flexible Flat Panel Displays, John Wiley & Sons, Ltd: Chichester, U K, 2005, pp 57-77.
(26) Bowles, M.; Jianjun, L. In Review on nanotechnology in agricultural products logistics management, 8th International Conference on Computing and Networking Technology (ICCNT), 27-29 Aug. 2012; 2012; pp 415-420.
(27) Yam, K. L.; Lee, D. S., Emerging food packaging technologies: Principles and practice. Woodhead Publishing: Cambridge, UK, 2012.
(28) Leterrier, Y., Durability of nanosized oxygen-barrier coatings on polymers. Prog. Mater Sci. 2003, 48, 1-55.
(29) Affinito, J. D.; Gross, M. E.; Coronado, C. A.; Graff, G. L.; Greenwell, E. N.; Martin, P. M., A new method for fabricating transparent barrier layers. Thin Solid Films 1996, 290, 63-67.
(30) Ploehn, H. J.; Liu, C. Y., Quantitative analysis of montmoroillonite platelet size by atomic force microscopy. Ind. Eng. Chem. Res. 2006, 45, 7025-7034.
(31) Tombácz, E.; Szekeres, M., Colloidal behavior of aqueous montmoroillonite suspensions: the specific role of pH in the presence of indifferent electrolytes. Appl. Clay Sci. 2004, 27, 75-94.
(32) Nielsen, L. E., Models for the Permeability of Filled Polymer Systems. Journal of Macromolecular Science: Part A—Chemistry 1967, 1, 929-942.
(33) Roberts, A.; Henry, B.; Sutton, A.; Grovenor, C.; Briggs, G.; Miyamoto, T.; Kano, M.; Tsukahara, Y.; Yanaka, M., Gas permeation in silicon-oxide/polymer (SiOx/PET) barrier films: role of the oxide lattice, nano-defects and macro-defects. Journal of Membrane Science 2002, 208, 75-88.
(34) Priolo, M. A.; Holder, K. M.; Greenlee, S. M.; Grunlan, J. C., Transparency, Gas Barrier, and Moisture Resistance of Large-Aspect-Ratio Vermiculite Nanobrick Wall Thin Films. ACS Appl. Mater. Interfaces 2012, 4, 5529-5533.

What is claimed is:

1. A method of preparing an oxygen barrier film, the method comprising:
a. obtaining a substrate;
b. exposing the substrate to a polycation solution with a pH of 6 or less to form a first layer; and
c. exposing the substrate with the polycation to a platelet solution to form a second layer;
wherein the first layer and second layer together form a bilayer; and
wherein the oxygen transmission rate of the oxygen barrier film is decreased compared to the oxygen transmission rate of the substrate.

2. The method of claim 1, wherein steps b and c are repeated until the number of bilayers reaches at least 10 bilayers.

3. The method of claim 2, wherein the thickness of the at least 10 bilayers is greater than 100 nm.

4. The method of claim 2, wherein the pH of the polycation solution or platelet solution is about 5 or less.

5. The method of claim 4, wherein the thickness of the at least 10 bilayers is at least 150 nm.

6. The method of claim 2, wherein the pH of the polycation solution or platelet solution is about 3 or less.

7. The method of claim 6, wherein the thickness of the at least 10 bilayers is at least 250 nm.

8. The method of claim 1, wherein the method further comprises rinsing with water after step b and after step c.

9. The method of claim 8, wherein the method further comprises drying after rinsing with water.

10. The method of claim 1, wherein exposing comprises dipping in a solution, spraying or flexographic printing.

11. The method of claim 1, wherein the method is layer by layer assembly.

12. The method of claim 1, wherein the polycation is selected from the group consisting of linear polyethylenimine (LPEI), branched polyethylenimine (BPEI), poly(allyl amine), poly(vinyl amine), cationic polyacrylamide, cationic polydiallyldimethylammonium chloride (PDDA), polymelamine and copolymers thereof, polyvinylpyridine and copolymers thereof, and combinations thereof.

13. The method of claim 1, wherein the substrate is polyethylene terephthalate.

14. The method of claim 1, wherein the platelet solution is an anionic platelet solution.

15. The method of claim 14, wherein the anionic platelet is selected from the group consisting of montmoroillonite, vermiculite, mica, zirconium phosphate, a graphene and a combination thereof.

16. The method of claim 15, wherein the anionic platelet is montmoroillonite.

17. The method of claim 2, wherein the at least 10 bilayers provide an oxygen transmission rate of less than 0.5 OTR (cc/(m²·day·atm)).

18. An oxygen barrier film made by the method of claim 1.
